(19) United States
(12) Patent Application Publication
(10) Pub. No.: US 2020/0143405 A1
(43) Pub. Date: May 7, 2020

(54) System and method to monetize the synchronized sharing of network-generated content through members of a virtual community

(71) Applicant: Matthew J. Tucker, Houston, TX (US)

(72) Inventor: Matthew J. Tucker, Houston, TX (US)

(21) Appl. No.: 15/876,238

(22) Filed: Jan. 22, 2018

(51) Int. Cl. G06Q 30/02; G06Q 50/00; G06Q 20/36; G06Q 40/02; G06F 21/10; G07F 17/32

(52) U.S. Cl. CPC G06Q 30/0215; G06Q 50/01; G06Q 30/0209; G06Q 30/0214; G06Q 20/36; G06F 2221/0713; G06Q 40/02; G06Q 30/0236; G06F 21/10; G07F 17/3255; G06Q 30/0235

(57) ABSTRACT

A promotional system and method to monetize the sharing of curated exclusive digital media to user-generated content networks through members of a virtual community, wherein individual and combined groups of members participate in game-like campaign segment interactions in between the publishing of media segments. Credits earned for completed shares and generated post interactions are exchanged at a pre-set rate for GoldCloud points (GCP) that are converted into monetary credits issued to a digital wallet.

### FIELD OF THE INVENTION

The present invention is in the field of digital media promotion, and particularly as it pertains to virtual communities such as social networks, online gaming communities and “virtual worlds”. Yet more particularly, the present invention pertains to monetization of the harmonized sharing of network-generated content to other social networks on the Internet through timed intervals of gameplay.

### BACKGROUND OF THE INVENTION

Since the explosion of social networking users around the world have been viewing and sharing media content. Large networks like YouTube thrive due to content published and shared. Online media can only “go viral” when it is viewed and shared.

In view of the foregoing, it would be effective and efficient to have a system and network that harnesses the power of the “share”.

### SUMMARY OF THE INVENTION

The inventor provides a digital media promotion system and method to monetize the sharing of curated exclusive media content (called GoldCloud campaigns) to a social profile on the connected social network, in which the publishing member participates in timed intervals of gameplay (known as campaign segment interactions) displayed in between the publishing of media segments. GoldCloud campaigns are created, curated and released to members of the virtual community by an administrator client from the administrative control panel. Members may also submit user-generated media, which upon approval, can be selected by the administrator to create user-generated GoldCloud campaigns (known as UGGC). Active campaign listings are displayed in GoldCloud user interface for members of the virtual community. Members may select each GoldCloud campaign and the network on which to publish.

The inventor also provides a method for members to create groups made up of other members (called GoldClouds) who share the same interest in exclusive media, wherein when the curating member initiates the sharing of a campaign, the participants of GoldCloud are notified and prompted to share the same campaign to the same social network. Members are awarded digital credits for completing campaign shares and generating post interactions on published media. Points earned during campaign segment interactions are converted into an in-network credits known as GoldCloud points (GCP) credited to the member's balance. Post interactions accumulated by newly published media are awarded as power points and also converted into GCP value. The contributing member is also credited GCP for each completed share of user-generated GoldCloud campaign (called UGGC) by other members in the virtual community. It is yet another novel aspect of the invention to convert set amounts of GCP into monetary credits issued to the digital wallet of the requesting member by a 3rd party payment processor. The system and method disclosed harnesses the power of sharing and effectively channels it to benefit the sharer. For the definition of terms, see the glossary proceeding the descriptions of the embodiments.

### BRIEF DESCRIPTION OF THE FIGURES

FIG. 1 illustrates system configured in accordance with an embodiment of the invention;

FIG. 1.1 illustrates an embodiment of the device on which software is executed;

FIG. 1.2 illustrates the user-generated media upload module wherein member client submits media for review by admin client;

FIG. 2.1 is a flow chart illustrating the process of setting network parameters;

FIG. 2.2 is a flow chart illustrating the novel process of creating a GoldCloud campaign;

FIG. 2.3 illustrates the dashboard of the administrative control panel;

FIG. 2.4 illustrates the settings module in the administrative control panel;

FIG. 2.5 illustrates the payout module in the administrative control panel;

FIG. 2.6 illustrates the campaign module of the administrative control panel;

FIG. 2.7 illustrates an example of a point table used in the administrative control panel;

FIG. 2.8 illustrates an example of a GoldCloud campaign;

FIG. 2.9 illustrates the leaderboard section of administrative control panel;

FIG. 2.10 illustrates the badge module in administrative control panel;

FIG. 3.1 is a flow chart illustrating the method of inviting new users into the virtual community;

FIG. 3.2 is a flow chart illustrating the novel method of creating and activating a GoldCloud;

FIG. 3.3 is a flow chart illustrating the novel method of completing a GoldCloud share;

FIG. 3.4 is a flow chart illustrating the novel method of the capture-share campaign segment interaction;

FIG. 3.5 is a flow chart illustrating the novel method of the campaign game campaign segment interaction;

FIG. 4 is a flow chart illustrating the novel method of the submission of a GCP conversion request;

FIG. 4.1 shows the interest selection view in user interface;

FIG. 4.2 shows the campaign listings view in user interface;

FIG. 4.3 shows the campaign detailed view in user interface;

FIG. 4.4 shows the instructions for Game 1 during campaign game segment interaction;

FIG. 4.5 shows the instructions for Game 2 during campaign game segment interaction;

FIG. 4.6 shows the instructions for Game 3 during campaign game segment interaction;

FIG. 4.7 shows the instructions for displayed during capture-share segment interaction;

FIG. 4.8 shows the campaign level completion dialogue;

FIG. 4.9 illustrates the conversion request module in GoldCloud user interface;

FIG. 5 is a flow chart illustrating the novel method of completing a campaign share;

FIG. 5.1 illustrates the game icons used in campaign games;

FIG. 6 is a flow chart illustrating the novel method of converting GCP into monetary credits.

### DETAILED DESCRIPTION OF PREFERRED EMBODIMENTS

### System of Invention

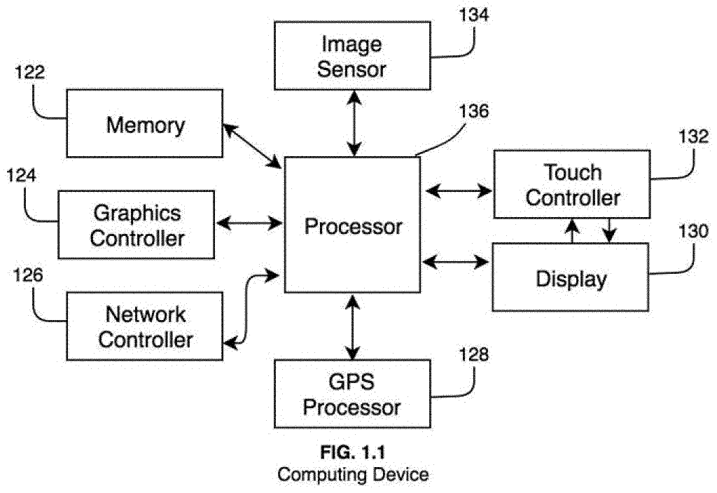

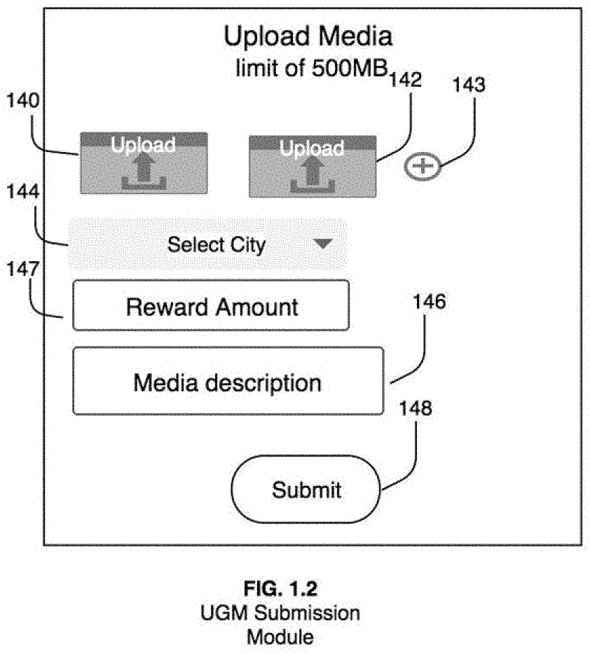

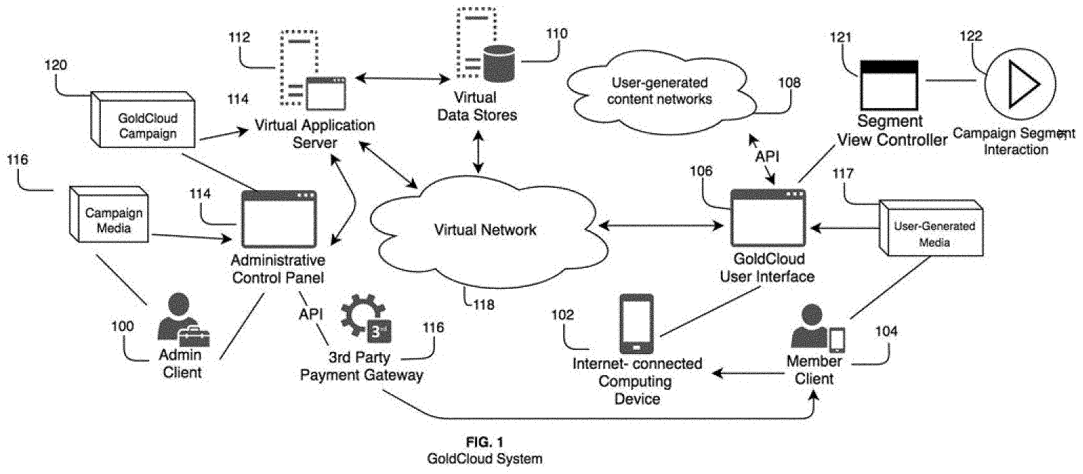

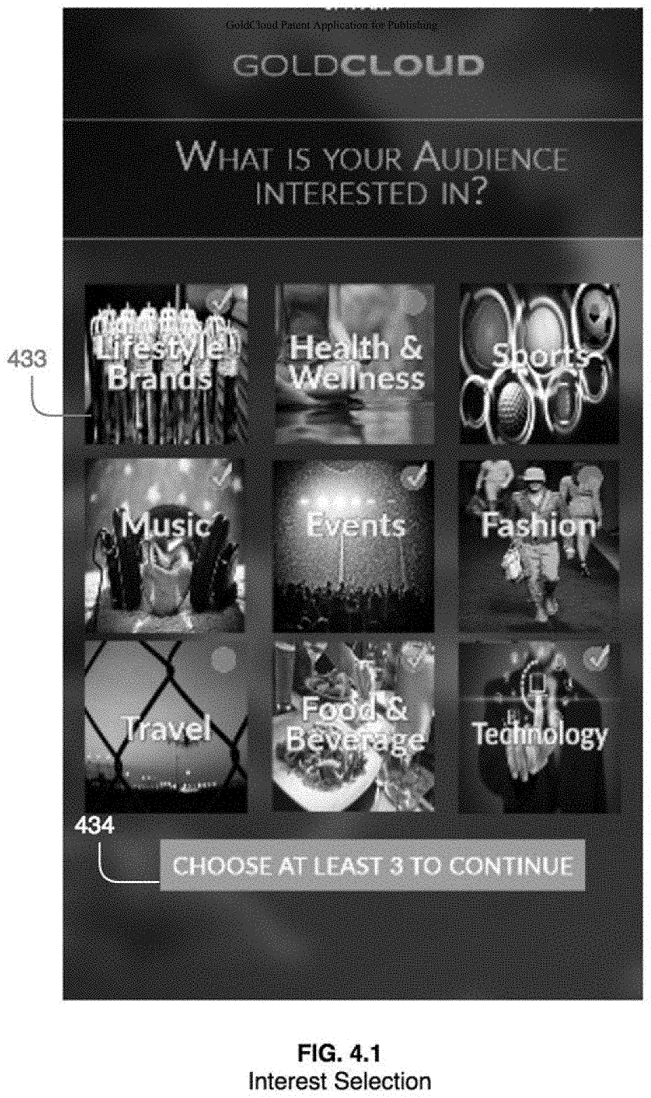

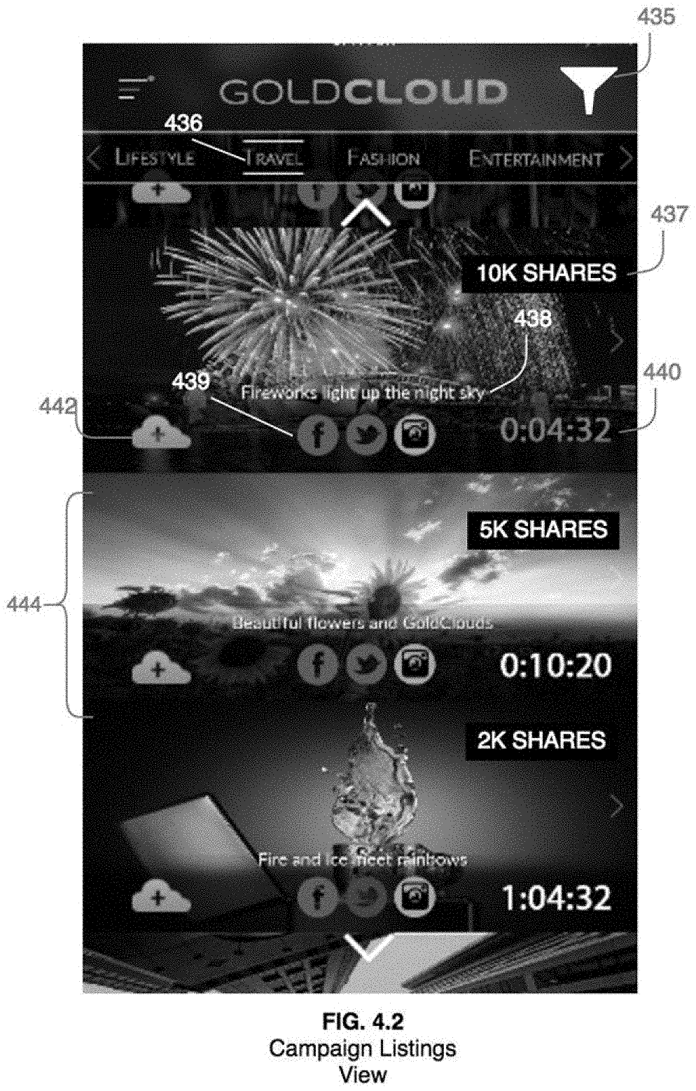

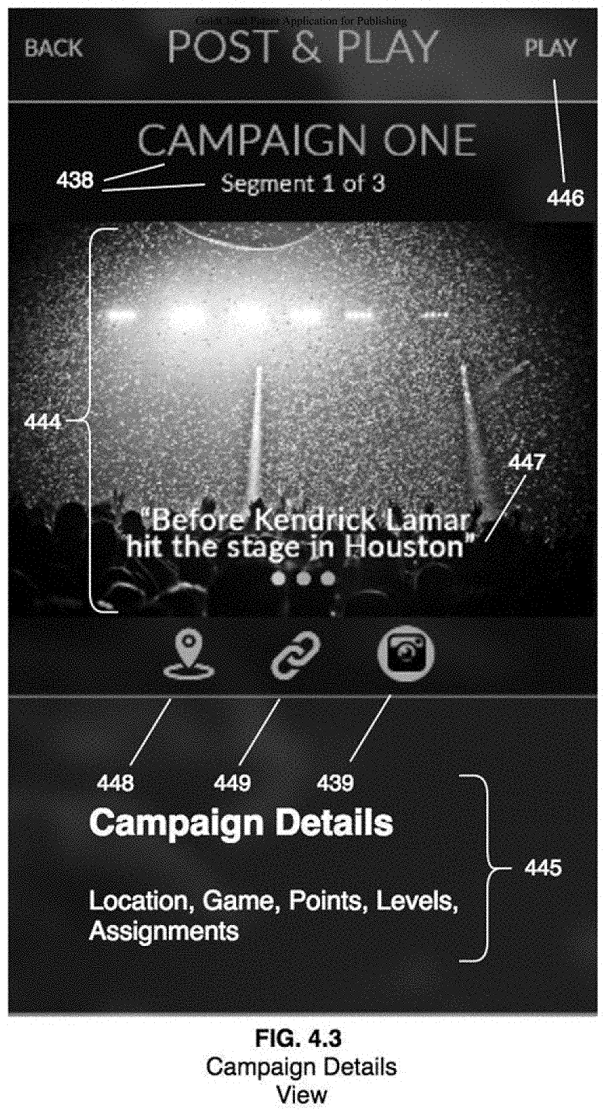

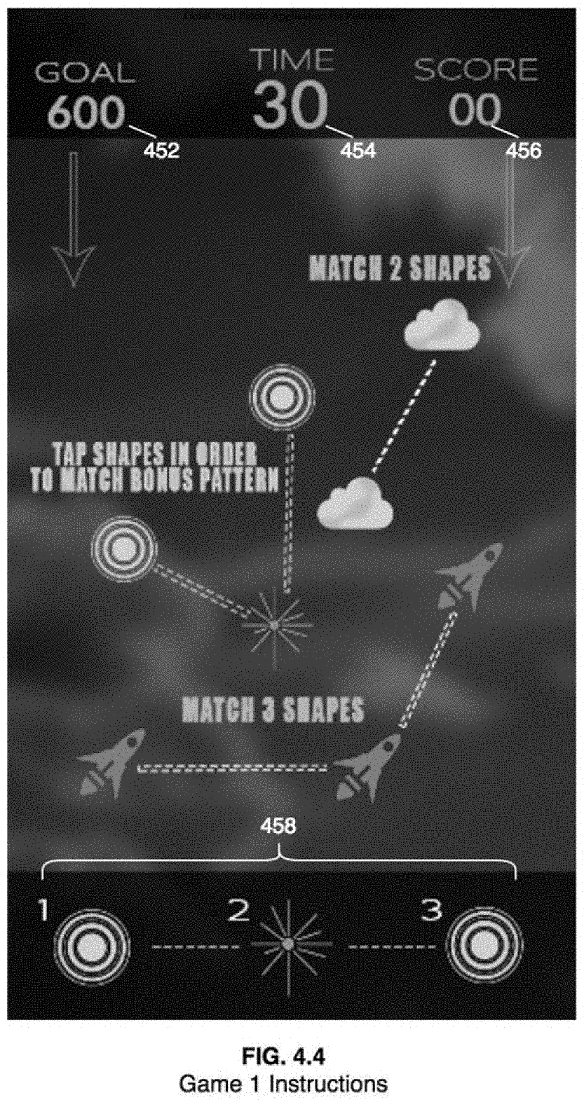

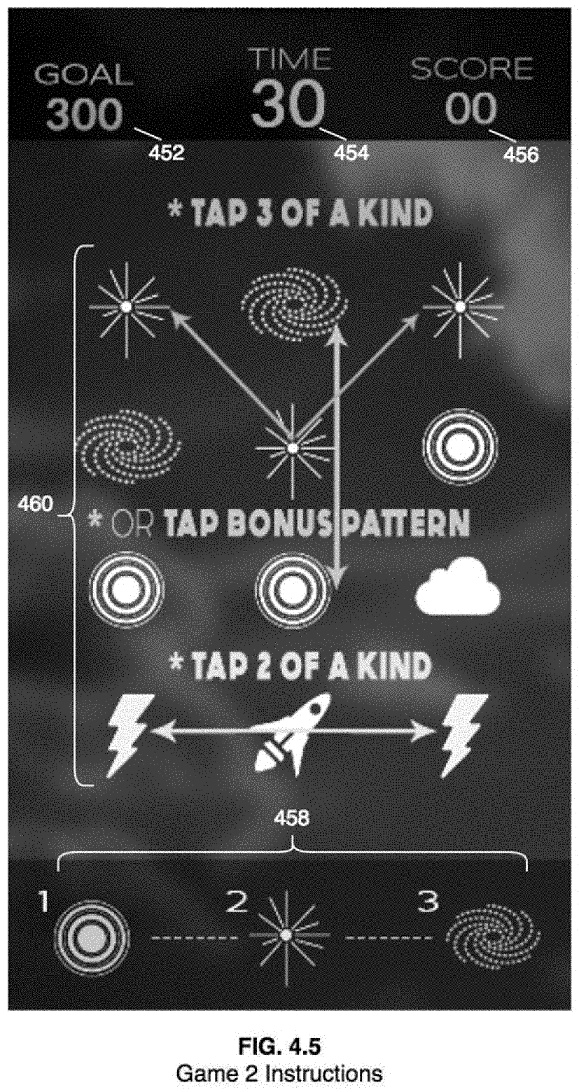

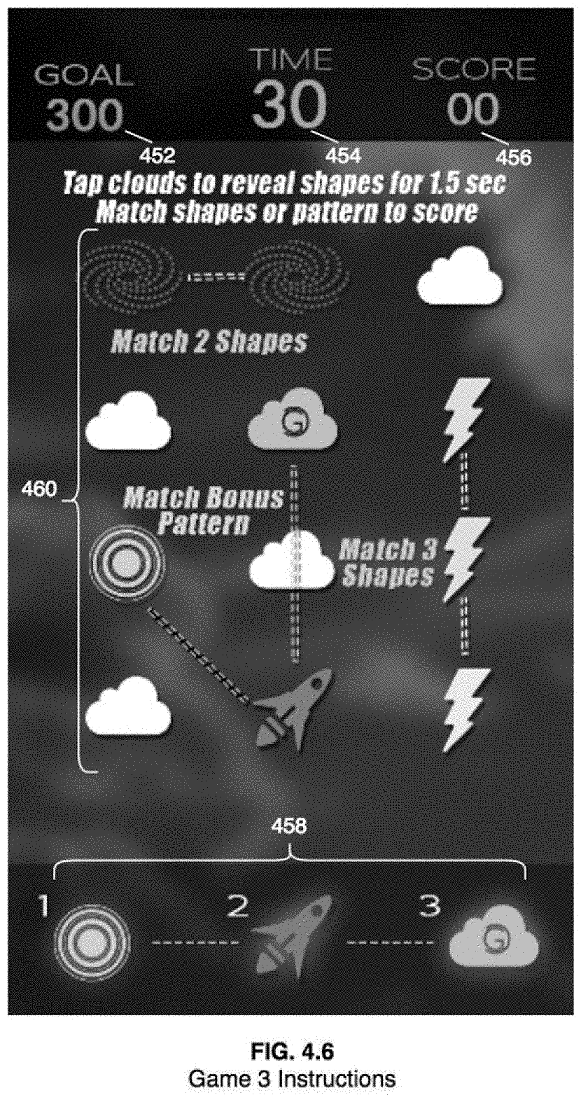

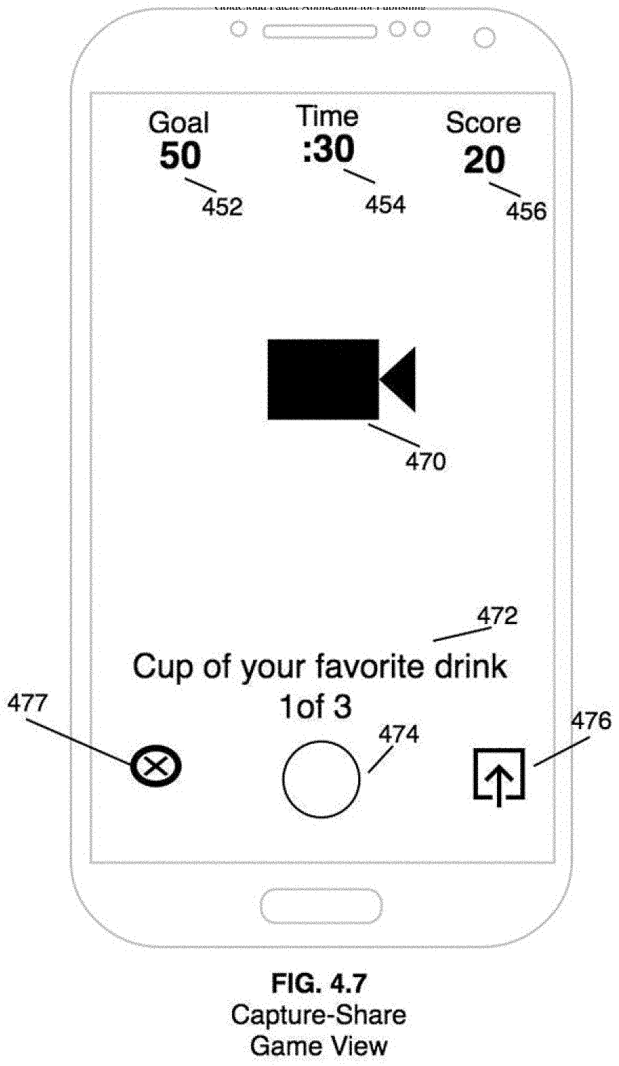

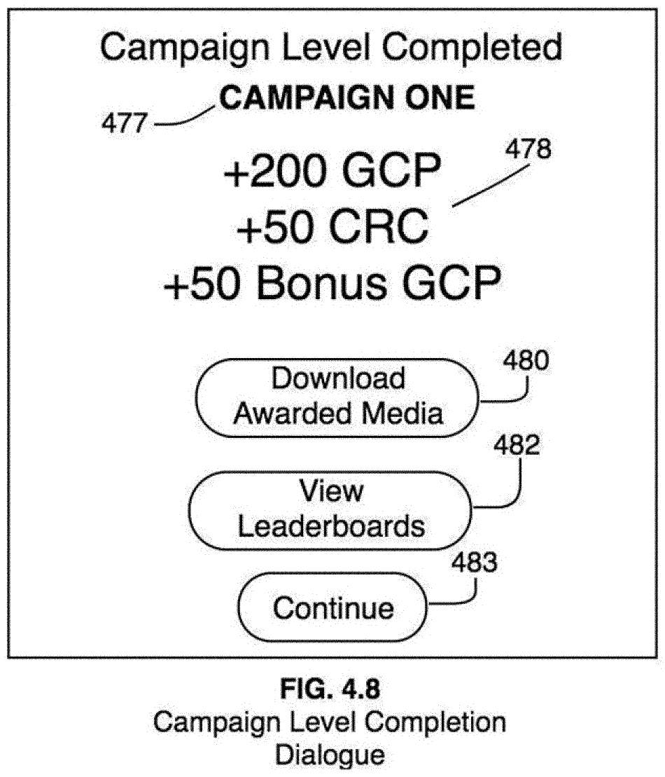

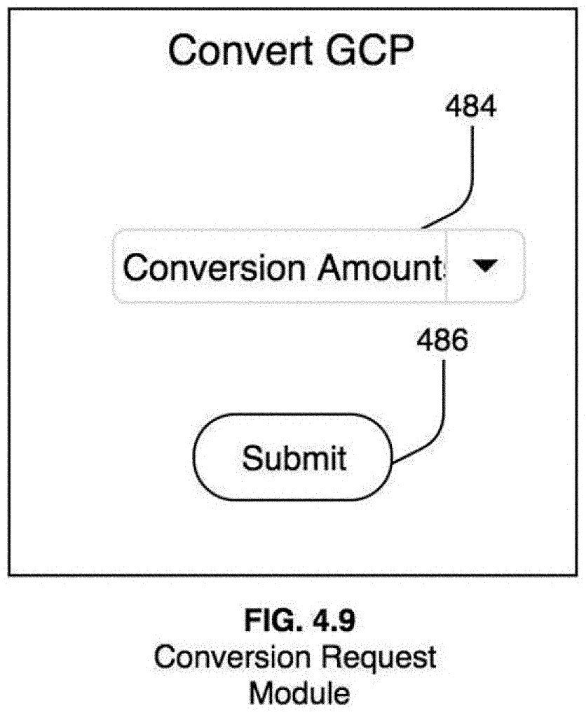

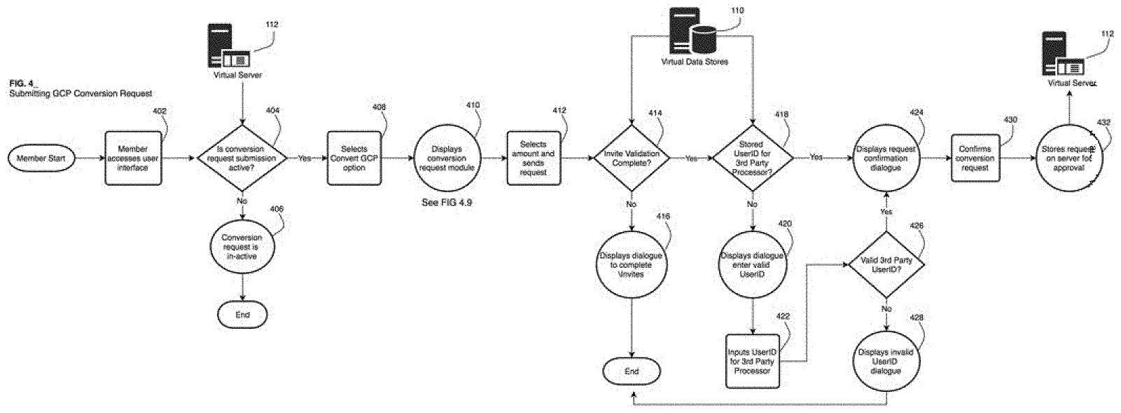

FIG. 1 is an illustration of the embodiment of the invention in which admin client 100 uploads campaign media 116 to administrative control panel 114 in order to establish GoldCloud campaign 120. Campaign media and parameters are uploaded to virtual server 112 and virtual data stores 110 to be displayed within virtual network 118, wherein member client 104 may access campaign listings on GoldCloud user interface 106 using internet-connected computing device 102. GoldCloud user interface 106 allows member client 104 to upload user-generated media 117 for review by admin client 100 from control panel 114, wherein upon approval, user-generated media 117 may be selected to establish a GoldCloud campaign 120. Using computing device 102, member client may browse active GoldCloud campaign 120 listings within virtual network 118 and publish media directly to a connected social profile on other user-generated content network 108 via API integration. Following the publishing of campaign media segments, member client 104 may participate in campaign segment interactions 122, wherein points are accumulated for haptic contact engagements completed within a timed interval. Member client 104 may send conversion request from conversion request module (shown in FIG. 4.9) within GoldCloud user interface 106 to administrative control panel 114 to be reviewed for approval or denial by admin client 100, wherein set amounts of accumulated points are requested to be converted into monetary credits. Upon approval of request by admin client 100, a 3^{rd} party payment processor, 116 issues credits to the digital wallet of requesting member client 104. In another embodiment, blockchain technology can be used to decentralize and secure the GoldCloud campaign 120 by storing the campaign data in the form of transactions.

### Computing Device

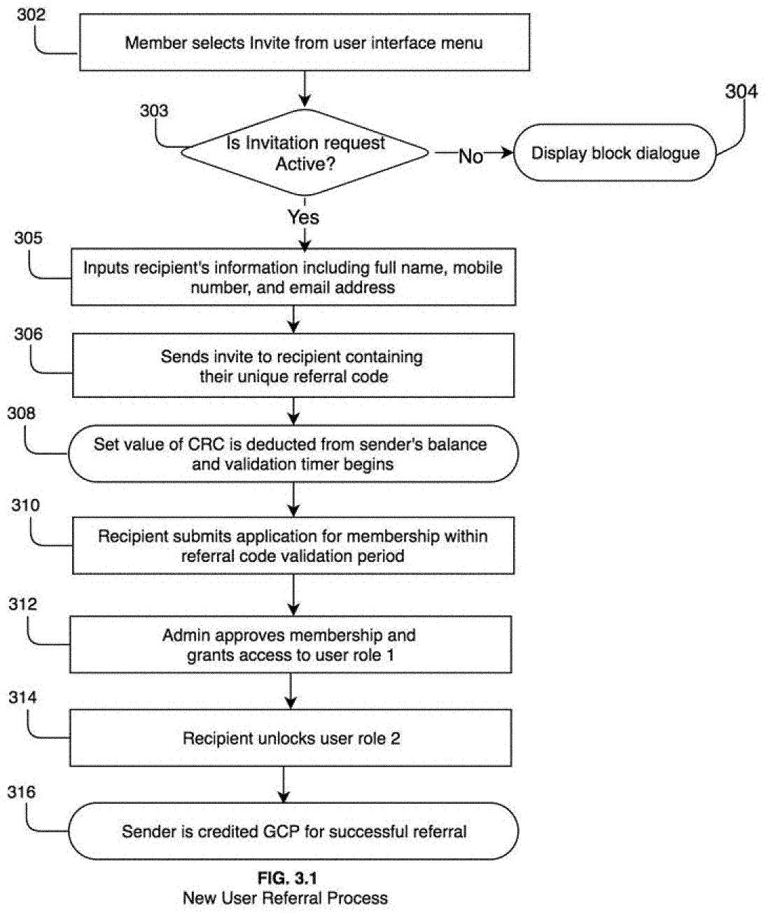

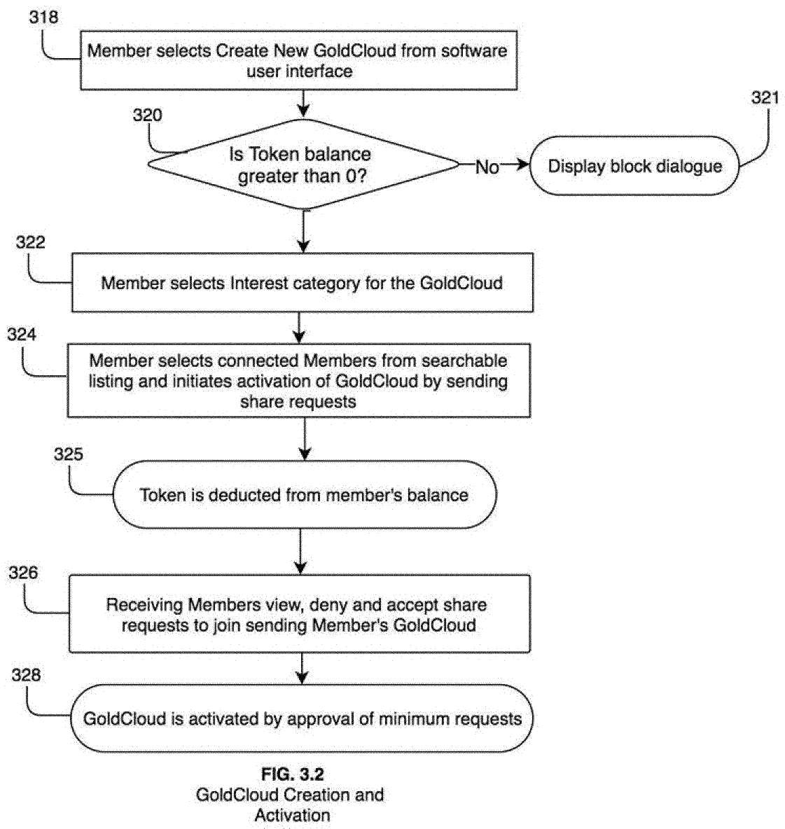

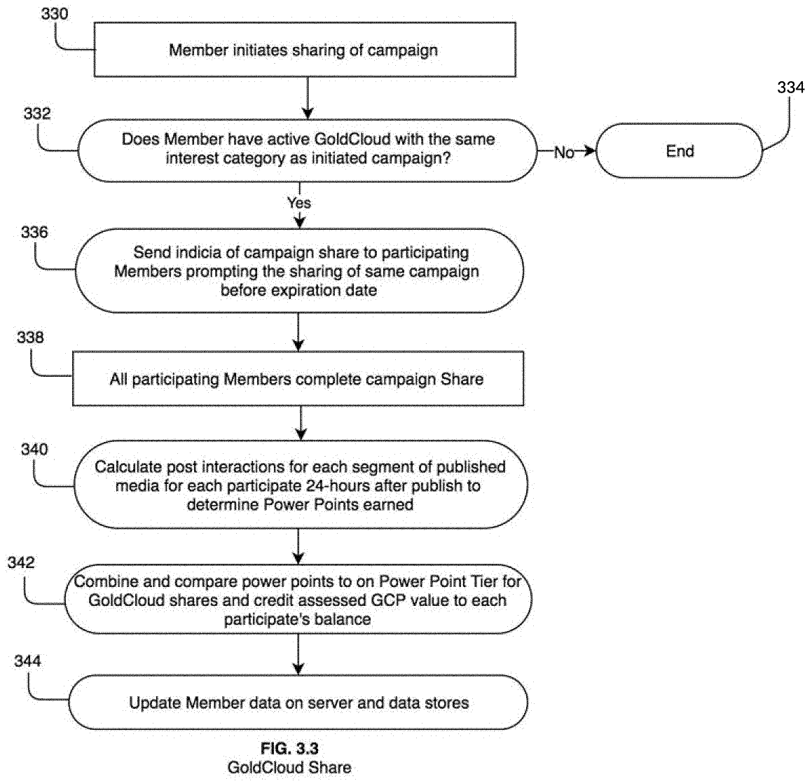

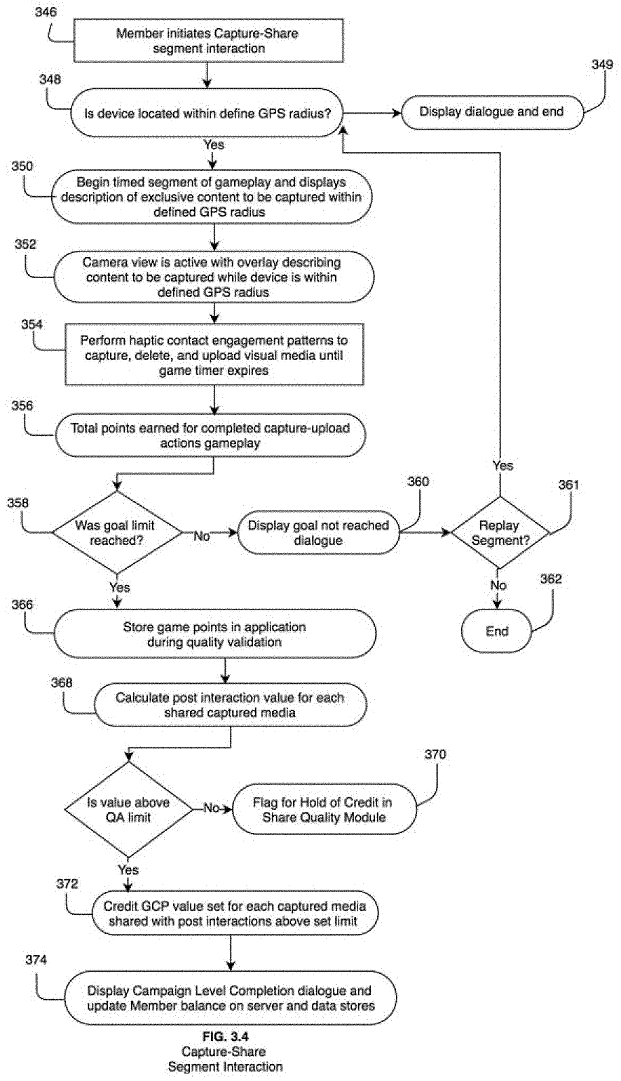

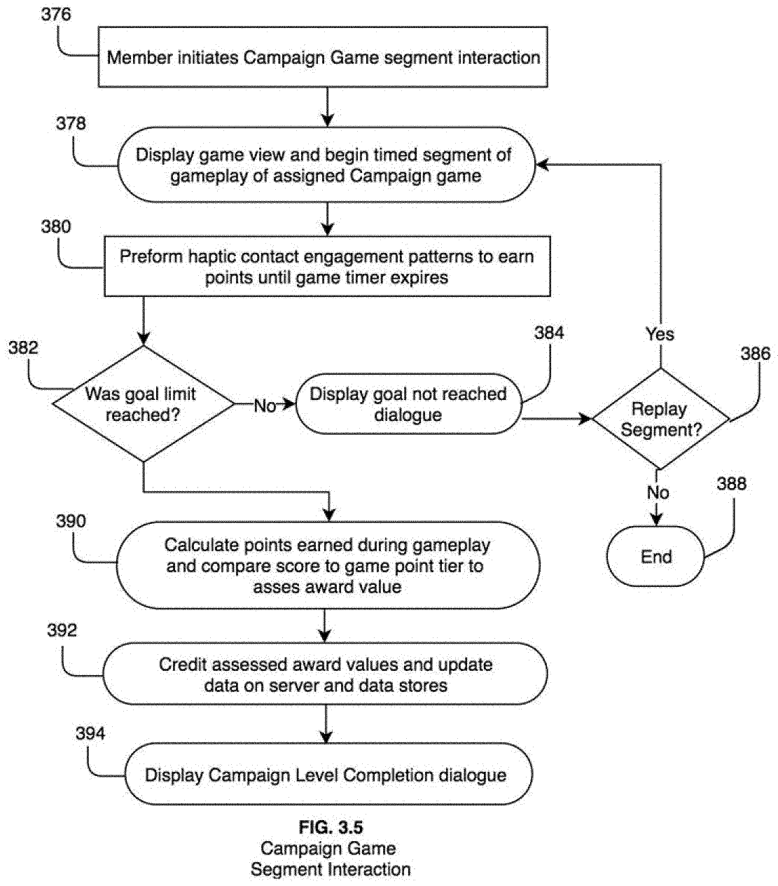

FIG. 1.1 illustrates a computing device 102, on which software is executed. In one embodiment of the invention, the computing device 102 is a smartphone with a processor 136 in communication with a memory 122. The processor 136 may be a central processing unit and/or a graphics processing unit. The memory 122 is a combination of flash memory and random access memory. The memory 122 stores user-generated media 117 submitted for incorporation in a GoldCloud campaign 120. The processor 136 is also coupled to image sensors 134 and the GPS processor 128. The image sensors 134 may be known as digital image sensors, such as charge-coupled devices. The GPS processor 128 verifies location during the capture-share campaign segment interaction process described in FIG. 3.4. The image sensors capture visual media, which is presented on display 130. Specifically, in capture-share campaign segment interaction 122 as displayed in FIG. 3.4, the image sensors 134 capture visual media and presents the visual media on the display 130 so that user can observe the captured visual media and upload to receive points.

A touch controller 132 is connected to the display 130 and the processor 136. The touch controller 132 is responsive to haptic engagements applied to the display 130. In campaign segment interaction 122, the user's haptic contact engagements unlock points as descried below in FIG. 3.4 and FIG. 3.5, being shown as instructed by segment view controller 121 on the display 130. Specifically, the view controller 121 follows parameters set in virtual server 112 and displays either a campaign game or capture-share segment interaction, each including executable instructions administered by the processor 136. A graphics controller 124 is connected to processor 136 to display graphics used in gameplay and media stored in memory 122. The network controller 126 is also connected to processor 136 to access the Internet and update virtual server data 112, as well as upload media 116 or 117 to virtual data stores 110.

In another embodiment, the computing device 102 can be an augmented reality or virtual reality device that displays campaign segment interactions 122, using an alternative view controller 121 interchangeably between the publishing of exclusive digital media to a connected social profile on a user-generated content network 108. Haptic contact engagements may be captured by a remote controller or sensor in the place of touch controller 132. In yet another embodiment, the computing device 102 can be a gaming system displaying campaign segment interactions 122 as timed game intervals displayed interchangeably between the publishing of exclusive digital media to a connected social profile on a user-generated content network 108, wherein haptic contact engagements are captured by a remote controller or sensor in the place of touch controller 132. In yet another embodiment, the computing device 102 can be an internet-enabled monitor, tablet, or interactive digital visual display that processes haptic engagements performed by the user.

### Setting Network Parameters

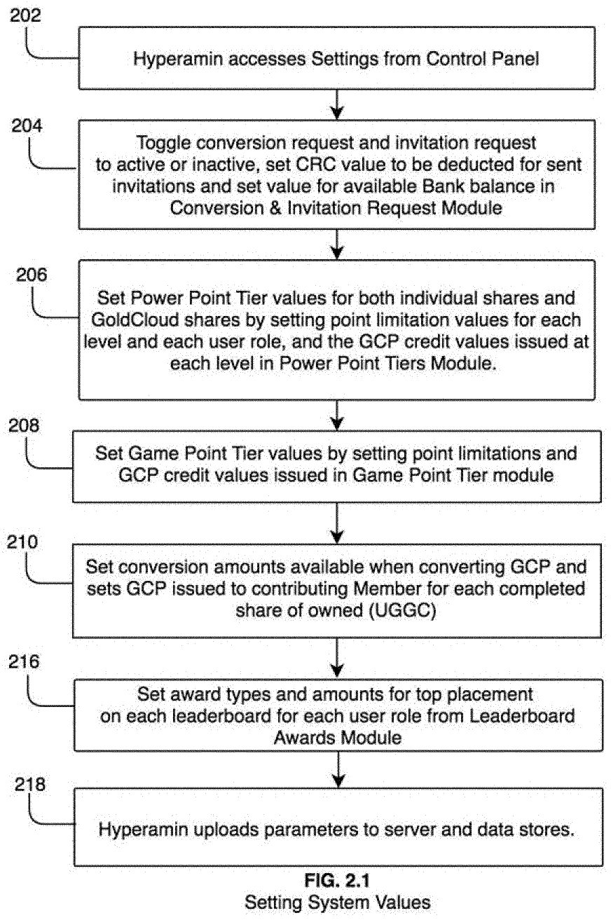

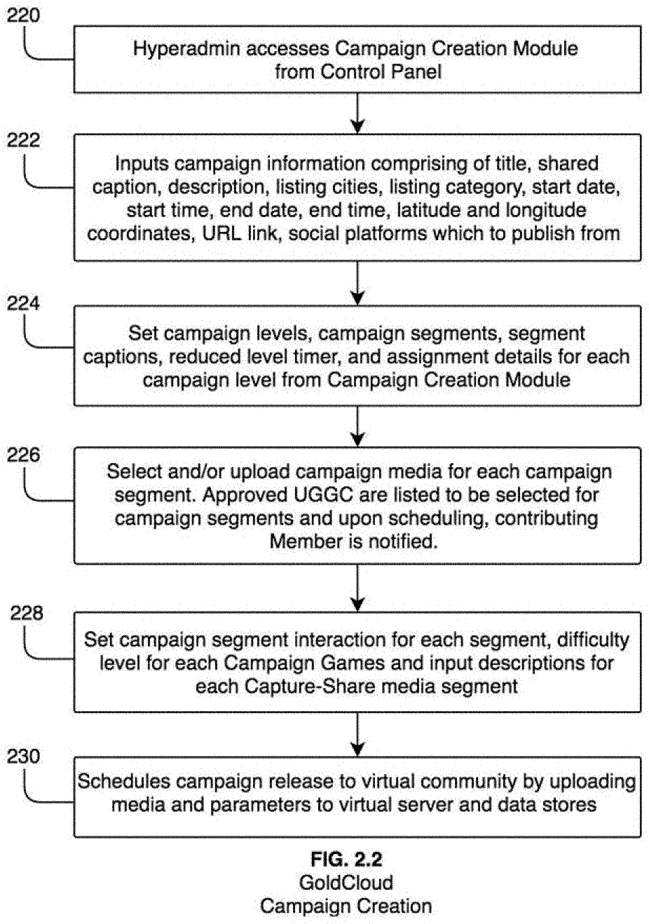

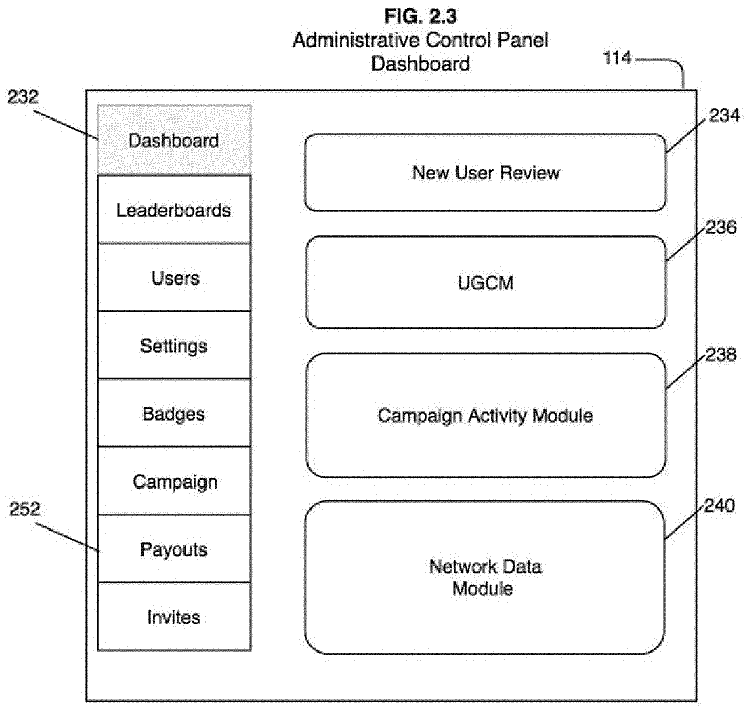

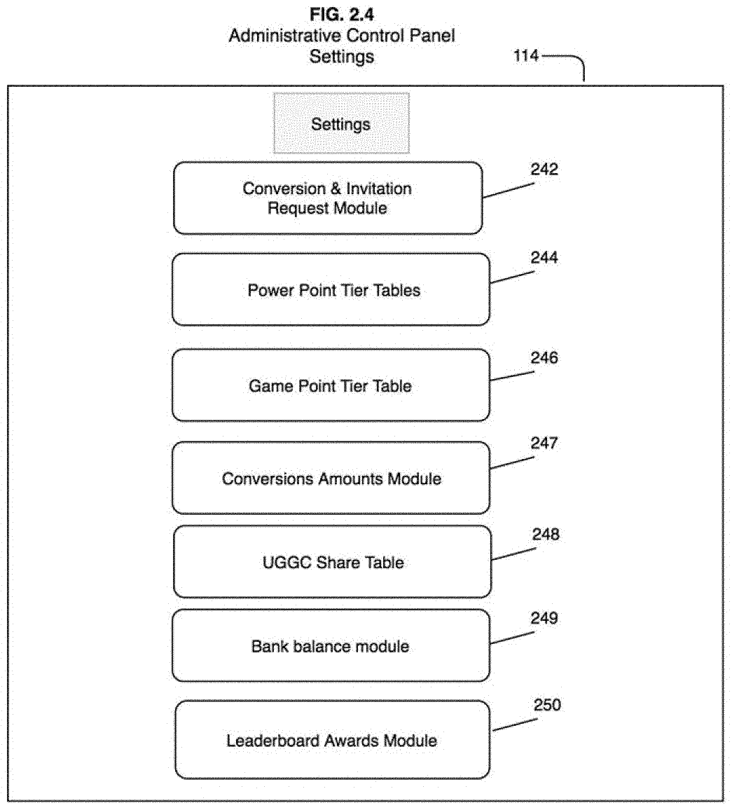

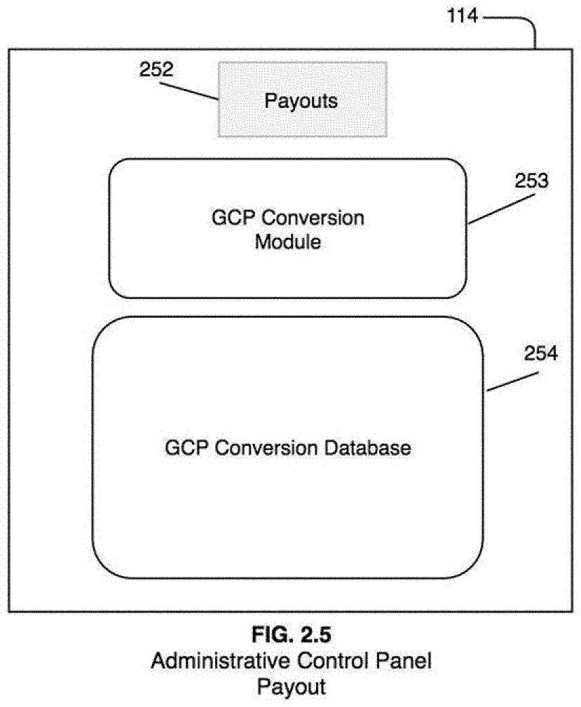

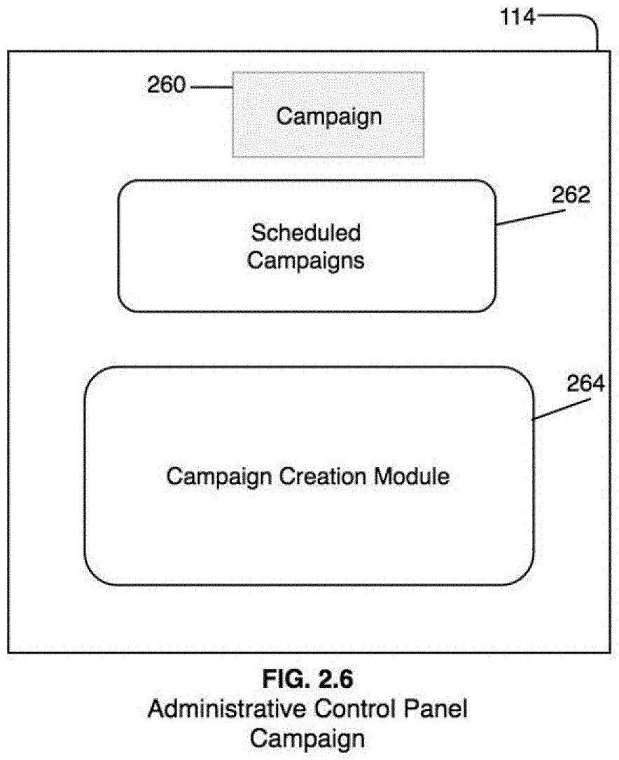

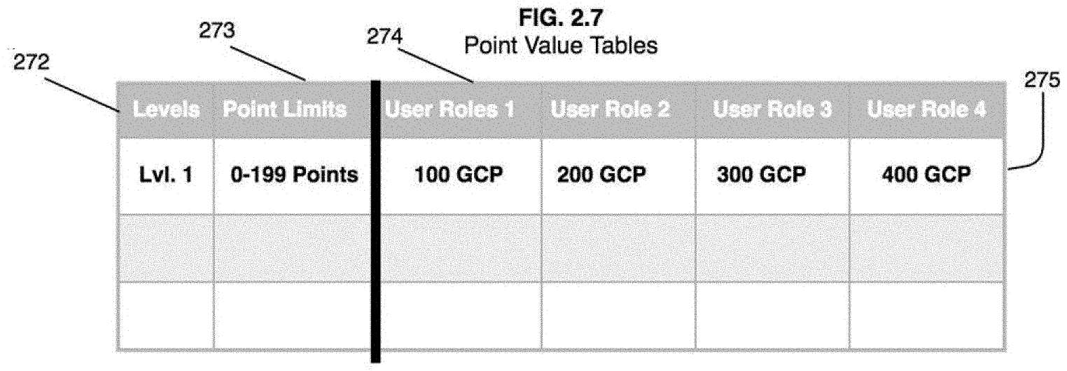

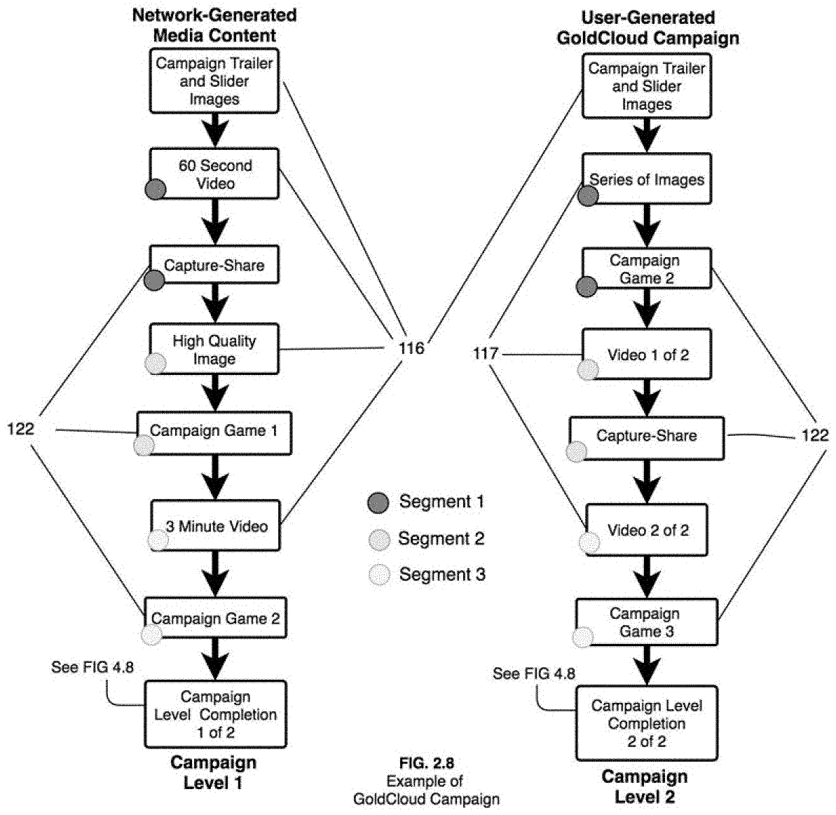

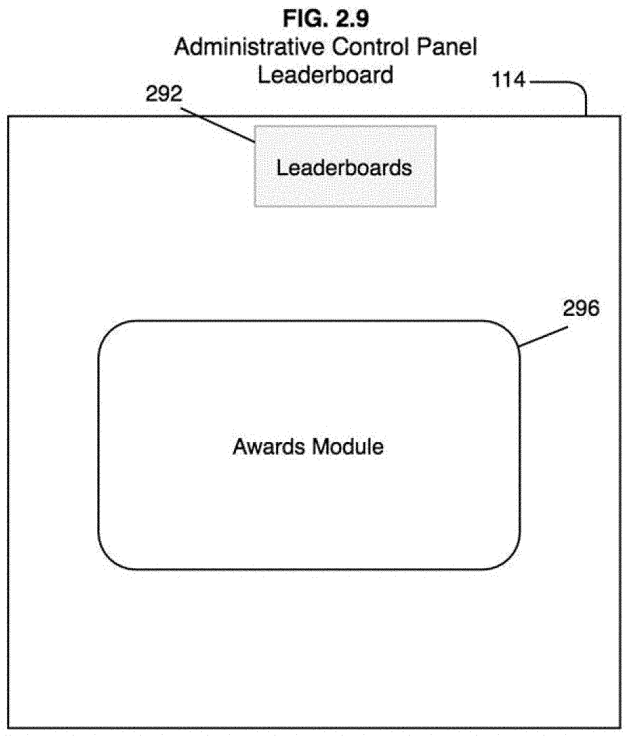

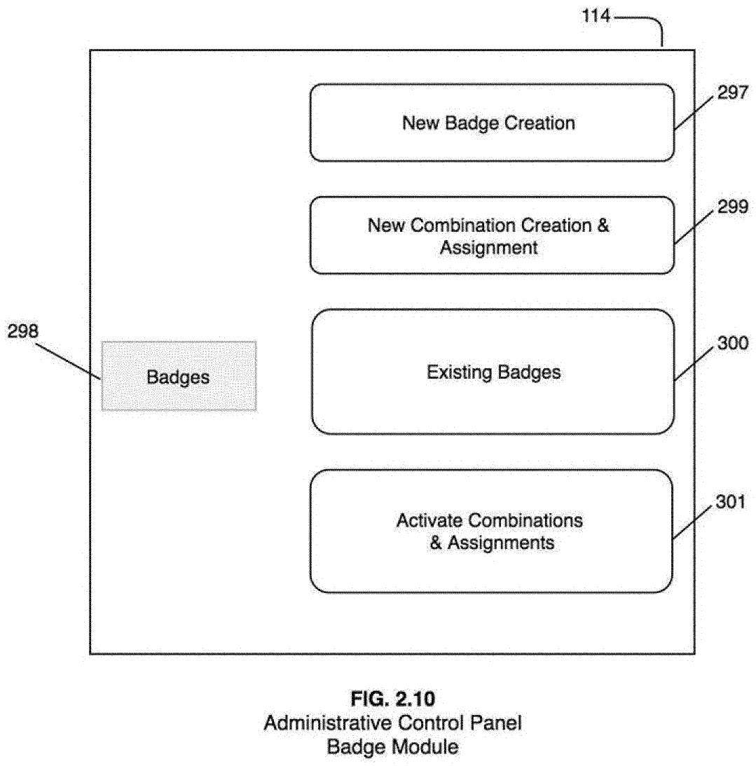

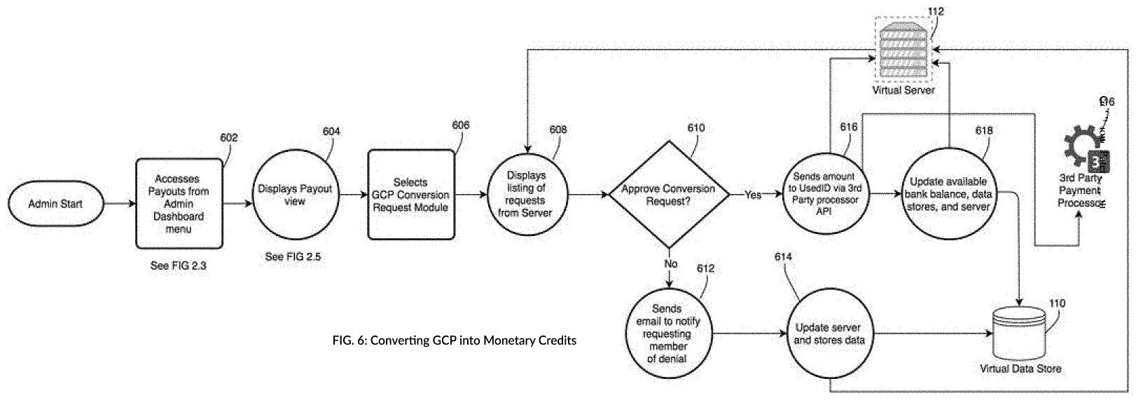

FIG. 2.1 describes the process of admin client 100 configuring the network parameters from the administrative control panel 114. The steps described in FIG. 2.1 are executed in the setting module illustrated in FIG. 2.4. Step 204 is executed from conversion and invitation request module 242 wherein the following limitations apply;
if toggle setting is to active, then members can access the respective module,
If toggle setting is set to inactive, then member is blocked from respective module and,
CRC value must be between 50-1000.
   Available bank balance is set in the bank balance module 249, wherein the admin client 100 may input a value to represent the available amount of credits. Once set, the available bank balance is displayed to all members and updated as GCP conversion requests are approved by admin client 100 and issued by 3^{rd} party payment processor 116 as described in FIG. 6.

Step 206 is executed from power point value tables 244 and are shown in the example in FIG. 2.7, wherein the following limitations apply:
all value limits are set in a range of less than 199 points from other limits on same award level 272 (example: 273 or 275 is 0-200, or 201-400, or 401-450),
or a break value higher than other limits may be set on the same award level 272, wherein all scores equal or higher to set value are awarded the same GCP value (example: 273 or 275 is 451+ Points).
   Once set, GCP values are awarded to each user role 274 for post interaction totals calculated 24 hours after publishing of exclusive media 122, wherein totals are compared to point limits ranges 273 set for each award level 272. Example table in FIG. 2.7 shows level 1 awards are credited to users with a post interaction total between 0-199 points. User role 1 members are credited 100 GCP while user role 2 members are credited 200 GCP, user role 3 members are credited 300 GCP, and user role 4 members are credited 400 GCP. Step 208 is executed from game point value tables 246 also represented in the example in FIG. 2.7 wherein the same limitations previously described apply to game point table 246. Once set, GCP values are awarded to each user role 274 for completing campaign segment interactions 122 with score totals within set point limits 273 for each award level 272.

Step 210 is executed from conversion amounts module 247, wherein values for GCP conversion and values of credits issued are set by admin to be displayed as listed amounts in conversion request module 484 (see FIG. 4.9) selectable by member client 104 from GoldCloud user interface 106 during the conversion request submission process charted in FIG. 4. GCP values credited to contributing members for completed shares of owned UGGC containing user-generated media 117 are set in UGGC share table 248, wherein the same limitations previously described apply to accumulated shares in the place of points in UGGC share table 248. Once set, GCP values are awarded to the contributing member based on user role 274 for completed campaign shares containing their owned user-generated media 117. Share totals are calculated 48 hours after publishing of media and compared to set share limits 273 for each award level 272 to determine GCP value to be credited to contributing member client 102.

Step 216 is executed from the leaderboard awards module 296 (see FIG. 2.9), wherein award type and value are set for each leaderboard on which member values are locally ranked by city. Leaderboards are displayed in GoldCloud user interface 106 accessed by member clients 104. Members may accumulate points from participation in community activities until the completion of a 7-day or 30-day cycle, wherein set awards are issued to the top 8 ranking members on each leaderboard, and then the leaderboards reset.

Step 218 is executed when admin client 100 taps the save settings button once parameters have been set. Parameters are uploaded to virtual application server 112 to be executed by user interface 106. As instructions and values are needed for every component of the system of invention, admin client 100 must establish network parameters from administrative control panel 114 in order for the system to complete operations. The administrative control panel 114 can be accessed on an internet-enabled computing device 102 using login credentials inputted on the secured web portal hosted on virtual server 112.

### Creating a Goldcloud Campaign

FIG. 2.2 describes the process of admin client 100 creating and scheduling a GoldCloud campaign 120 to be listed as a campaign listing (see FIG. 4.2) in the user interface 106. In step 220, admin client 100 accesses campaign creation module 264 shown in FIG. 2.6 located within administrative control panel 114. In step 222, admin client 100 inputs campaign information to be displayed on the campaign listings (see FIG. 4.2) and campaign details (see FIG. 4.3) including title 438, description 445, listing cities accessed via filter icon 435, listing category 436, latitude and longitude coordinates 448, URL link 449, social platforms which to publish campaign media 439, start date & start time, and end date & end time as displayed in countdown to set end time activated at set start time on set start day 440.

### Campaign Parameters

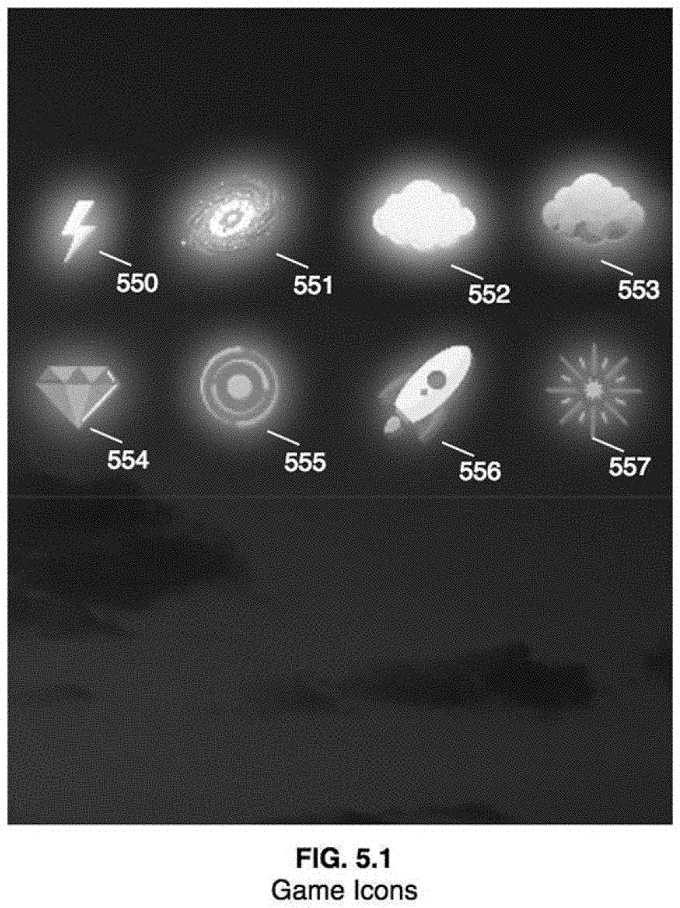

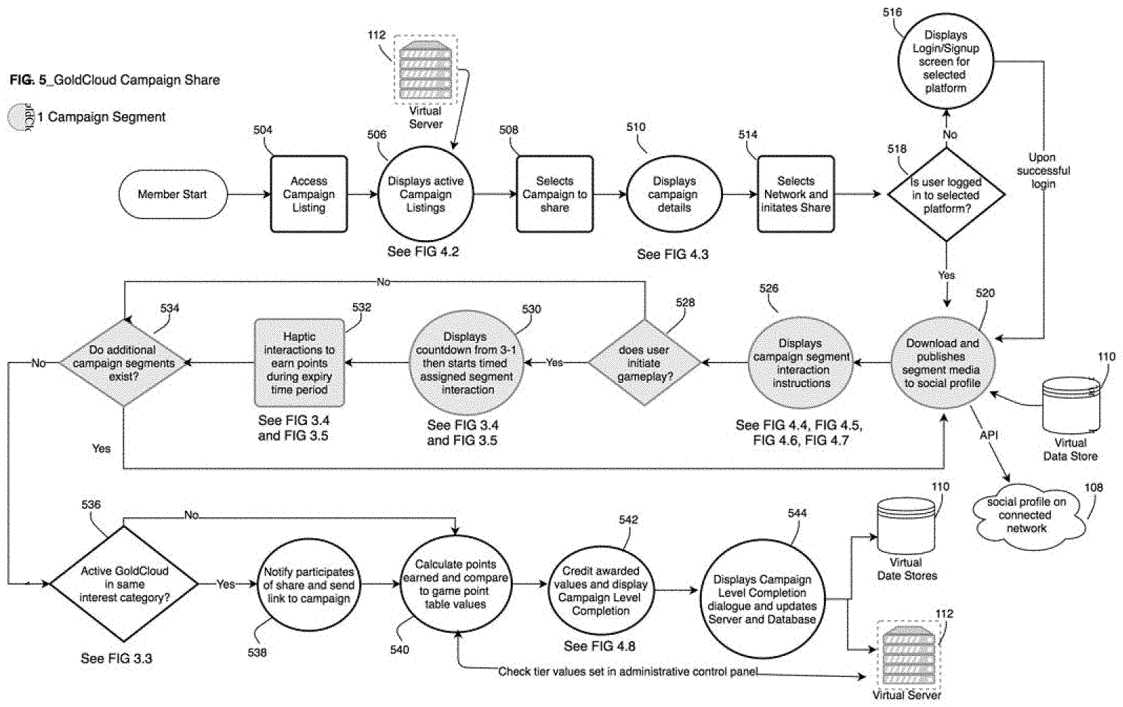

In step 224, admin client 100 sets campaign parameters to be executed during member initiated-campaign share illustrated in FIG. 5. Campaign levels are comprised of campaign media, shared caption 447 for each segment of media published to selected platform 108, campaign segment interactions 122 as described below, a reduced level timer 440 wherein a fixed duration of time may be set for member client 104 to complete level before resetting to first level, and assignment details wherein additional credits are awarded to member client 104 for completion of level within defined time period. Campaign levels may contain a maximum of 9 campaign segments. It is a novelty of the invention in that each campaign segment may contain one media 116 or 117 to be published in one posting on receiving platform 108 followed by one campaign segment interaction 122 as illustrated in FIG. 2.8. These two steps can be repeated multiple times by creating additional campaign levels, creating a cycle of incentivized sharing and gameplay, wherein member client 104 is awarded with power points and game points respectively for effectively publishing provided media and for their participation in interactions, which are exchanged for GCP, and GCP is convert into monetary credits issued to a digital wallet by 3^{rd} party payment processor 116. Downloadable media 480 may also be uploaded as incentives awarded to member clients 104 from the campaign level completion dialogue (see FIG. 4.8).

### Uploading Campaign Media

In step 226, admin client 100 uploads campaign media 116 and/or selects user-generated media (UGM) 117 for each campaign segment created. Campaign media also includes visual media displayed in user interface 106 comprising of slider media (video and images) 444. Campaign media is pre-formatted to be displayed natively on the receiving platform 108. That is, the uploaded or submitted media has been edited to fit the format acceptable by the platform on which the media is to be published.

### UGM & UGGC

User-generated media 117 may be uploaded by member client 104 using UGM submission module illustrated in FIG. 1.2 accessed in user interface 106; wherein 140 and 142 represent UGM 117 segments, 143 represents icon to add another media segment, 144 represents the listing city selection, 146 represents the input field for description of media, 147 represents the input field for assignment bonus credited to other members for completing share and 148 represents the submission button, which uploads all data to virtual data stores 110 for display in user-generated content module or UGCM 236 (see FIG. 2.3). Upon submission, a token is deducted from the member client's balance and the submitting member's user id is added to UGM 117 as “contributing member”, displayed in media description 146 for the term of UGM 117 existence within the virtual network 118. Contributing member client 104 is notified as the submitted UGM 117 is denied, approved, scheduled, and shared by the virtual community. Assignment bonus value 147 set by contributing member client 104 is deducted from their balance and credited to a set number of first sharers of approved UGGC as “bonus GCP”. Contributing member client 104 is awarded GCP values set in UGM share table 248 for completed shares accumulated and credited to their balance every 24-hour period UGGC is active within the virtual network.

### Campaign Segment Interactions

In step 228, admin client 100 selects campaign segment interaction 122, wherein they choose which type of interaction member client 104 will encounter; either a capture-share process as described in FIG. 3.4 or campaign games process as described in FIG. 3.5, for each segment created in each campaign level. Each campaign segment interaction has a game timer 454, score counter 456, and a goal limit 452 displayed in segment view controller 121. Goal limit 454 must be reached in order to progress in the campaign share process, as illustrated in FIG. 5. Goals limits 452 are set by campaign game difficulty level (levels 1-5) and by the number of subject descriptions 472 set for capture-share segment (in the range of 2-9).

### Capture-Share

Initiating capture-share segment 346 requires member client's device 102 to be located within defined GPS location 448 in order to participate as illustrated in 348 and 349. That is, the capture-share segment interaction requires member client 104 to capture and upload visual media to selected social network 108 while device 102 is located within the defined GPS location 448 to earn points. Admin client 100 establishes capture-share segment by defining GPS radius for campaign 448, inputting descriptions of each subject 472 to be captured during allotted gameplay as illustrated in FIG. 4.7; setting camera mode 470 on image sensors 134 for each subject is to be captured (video or image), and inputting a value for QA limit for the capture-share segment to determine the quality of posts, wherein post interactions accumulated by each post is calculated within initial 3 hours after publishing and must be equal or greater than QA limit in order for member client 104 to receive credit for capture-share action.

During capture-share gameplay, subject descriptions 472 are displayed one at a time as completed in segment view controller 121, wherein member client 104 can view surroundings in set camera mode 470, and perform a haptic contact engagement pattern to capture described media by tapping icon 474 and upload captured media by tapping icon 476 to complete a description 472. Once upload is confirmed, next description 472 is displayed in game view. The game timer is paused during upload and resumes countdown upon the display of next description 472. Member client 104 is awarded 20 game points for each capture-upload action completed within defined GPS radius 448 before game timer 454 expires.

The number of descriptions 472 set by admin client 100 determines the difficulty level of segment interaction wherein a goal limit 452 is 60% of the point value accessed for the number of descriptions 472 set by admin client 100. Example: 3 descriptions 472 have a goal limit 452 of 36, and 6 descriptions 472 have a goal limit 452 of 72.

Game points earned during segment interaction are stored in the application during the quality validation period, wherein post interactions are calculated within the initial 3 hours of publishing captured visual media to verify the quality of the content. Published media that has a post interaction value lower than the QA limit set by admin client 100 is then disqualified and the awarded game points are deducted from the stored score. Published media that accumulate an amount of post interactions equal to or greater than QA limit, qualify to be included in the stored score total to be compared to game point table 246 for assessment of awarded GCP value.

### Campaign Games

A campaign game segment 122 displays wrapped nodes that appear as these items: yellow lightning bolt 550, orange-white galaxy 551, purple gem 554, gold cloud 553, blue reflector 555, red rocket 556, orange-yellow spark 557, and white cloud 552 as illustrated in FIG. 5.1. Game icons are displayed in view game view controller in randomized patterns while applying a rate of motion for various time intervals. Each campaign game follows a basic set of hard-coded instructions that controls the randomization, defined play area, haptic contact engagement patterns, and point logic. Goal limit 452, rate of motion, and display time intervals are determined by campaign difficulty level (level 1-5).

### Game 1

In one embodiment of campaign game segment interaction; in campaign game one 122, random game icons fall downward from the top of screen at a rate of motion defined by set difficulty level, while member client 104 is required to interact with 2 or 3 matching icons or randomly generated bonus pattern 458 to accumulate points as illustrated in FIG. 4.4. Haptic contact engagements that are awarded points are as follows:
1. Tap 1^{st} icon and slide to connect either matching icon or 2^{nd} icon displayed in bonus pattern 458,
2. Release contact to collect 2 matches or continue,
3. Slide to connect 3^{rd} matching icon or 3^{rd} icon in bonus pattern 458.
   Point logic is as follows:
If 2 icons matched, user is awarded 2 points
If 3 icons matched, user is awarded 3 points
If 3 gold clouds matched, user is awarded 5 points
If bonus pattern is matched, user is awarded 10 points
   Falling motion is suspended for icons included in haptic contact engagement. Matched icons are removed from view. Motion is unsuspended for unmatched icons. If the user can't achieve goal limit 452 before game timer 454 expires, then must play segment again or forfeit the share. If the user achieves goal 452, then score 456 is saved in the application to be compared to game point table 246 at the completion of the current campaign share.

### Game 2

In another embodiment of campaign game segment interaction; in campaign game two 122, game icons are displayed in 3×4 grid 460 on screen and keep changing in groups of 3-6 icons, only pausing for 1-2 second time intervals defined by set difficulty level, wherein member client 104 is required to interact with 2 or 3 matching icons or randomly generated bonus pattern 458 to accumulate points as illustrated in FIG. 4.5. Haptic contact engagements that are awarded points are as follows:
1. Tap 1^{st} icon and slide to connect either matching icon or 2^{nd} icon displayed in bonus pattern 458,
2. Release contact to collect 2 matches or continue,
3. Slide to connect 3^{rd} matching icon or 3^{rd} icon in bonus pattern 458.
   Point logic is as follows:
If 2 icons matched, user is awarded 2 points
If 3 icons matched, user is awarded 3 points
If 3 gold clouds matched, user is awarded 5 points
If bonus pattern is matched, user is awarded 10 points
   Randomized changing of icon is suspended for icons included in haptic contact engagement. Matched icons are removed from view and replaced with another icon. Randomized changing is unsuspended for unmatched icons. If the user can't achieve goal limit 452 before game timer 454 expires, then they must play the segment again or forfeit the share. If user achieves goal 452, then score 456 is saved in the application to be compared to game point table 246 at the completion of the current campaign share.

### Game 3

In yet another embodiment of campaign game segment interaction; in campaign game three 122, random game icons are displayed in 3×4 grid 460 on the screen for 1-2 second time intervals defined by set difficulty level, then replaced by white cloud 552 icons wherein member client 104 is allotted 5 seconds to interact with white clouds 552 to reveal 2 matching icons or randomly generated bonus pattern 458 to accumulate points before a new set of game icons are randomly generated (see FIG. 4.6). This 5-second cycle will repeat until game timer 454 expires. Haptic contact engagements that are awarded points are as follows:
1. Tap 1^{st} white cloud 552 icon and icon is revealed,
2. Tap 2^{nd} white cloud 552 icon and reveal matching icon or 2^{nd} icon in bonus pattern 458,
3. Tap 3^{rd} white cloud 552 icon to reveal 3^{rd} icon in bonus pattern 458.
   Point logic is as follows:
If 2 icons matched, user is awarded 2 points
If bonus pattern is matched, user is awarded 10 points
   Matched icons are removed from view and an empty space is displayed until grid rest. Unmatched icons are covered by white cloud 552. If the user can't achieve goal limit 452 before game timer 454 expires, then they must play segment again or forfeit the share. If user achieves goal 452, then score 456 is saved in the application to be compared to game point table 246 at the completion of the current campaign share.

The unique aspects described in the presented embodiments of the campaign game are the 30-second expiry game timer, haptic contact engagement patterns, awarding 2 and 3 game icon matching, and implementation of a randomized bonus pattern. New embodiments of campaign games may be created using additional icons functioning with the same unique aspects above and customized settings for motion, randomizations of icons, and gameplay area.

In step 230, admin client 100 schedules GoldCloud campaigns to be released by uploading all campaign media 116 or 117 and parameters to virtual data store 110 and application server 112, wherein upon start date and time, the campaign will be displayed as an active campaign listing for member client 104 in user interface 106 until the end date and time is reached. The scheduled campaign is managed by admin client 100 from listed scheduled campaigns 262 in campaign module 260 within administrative control panel 114. The GoldCloud campaign as described above and illustrated in FIG. 2.8 is a novel component of the invention, wherein the combination of visual media and gameplay segments are used to create an incentivized social media promotional campaign.

### Sending Invitations to New Users

FIG. 3.1 describes the process of member client 104 sending an invitation to a new user to join the virtual community, wherein the new user must input the unique referral code included in the invitation during a 48-hour validation period in order to submit a membership application to be reviewed, denied, or approved by admin client 100 from new user review module 234 on dashboard 232 (see FIG. 2.3) of administrative control panel 114. In step 302, member client 104 accesses invite module from user interface 106. If the invitation request toggle is set to inactive in conversion and invitation request module 242, then the invite module will be blocked 304 in user interface 106. In step 305, member client 104 inputs recipient's full name, mobile number, and email address which are stored for verification during the validation period. In step 308, the CRC value set in conversion and invitation request module 242 is deducted from the sender's balance for each invitation sent. The validation period begins upon the deduction of CRC value and lasts for 48 hours.

In step 310, the recipient installs the software on the device and submits an application with the 48-hour validation period. In step 312, admin client 100 reviews, denies or approves the membership application from new user review module 234, and upon approval, new member client 104 is granted access to user role 1. In step 314, new member client 104 unlocks user role 2 by purchasing access to GoldCloud campaigns released in a selected city. In step 316, the sender member is credited 500 GCP and one successful referral by the program. Member clients must submit three successful referrals within a 20-day window from the date GCP conversion request is submitted. That is, member client 104 must complete 3 successful referrals of new users within 20-days upon a submitted conversion request. Invited users who join the virtual community and unlock role 2 are connected to their referring members as “connected members”, and eligible to receive share request to participate in GoldClouds.

### Interest Selection

FIG. 4.1 shows the interest selection view wherein member clients 104 may choose what type of exclusive media they would like to share with social audiences on other platforms 108. Each interest 433 is a listing category for GoldCloud campaigns 120. Once the membership application is approved, member clients 104 are required to choose at least three categories and selection by tapping button 434. Once saved, interest categories 436 are displayed on the campaign listings view in user interface 106 as shown in FIG. 4.2.

### Establishing and Activating Goldcloud

FIG. 3.2 describes the process of member client 104 creating and activating a GoldCloud. In step 318, member client 104 initiates creation of a GoldCloud from user interface 106. Establishing and activating a GoldCloud is a novel method of invention as this process joins members together in preparation for harmonized sharing of exclusive media. Once creation is initiated, the system verifies token balance 320, and if the balance is zero, then block dialogue is displayed 321. Member client 104 selects interest category 433, in which to establish GoldCloud in step 322. Connected members are displayed to member client 104 and selected to receive a share request in step 324. In step 325, one token is deducted from the member's balance upon the sending of a share request. In step 326, share requests are sent to recipients for review in user interface 106, wherein the recipient may approve or deny a request. If the recipient agrees to participate in the harmonized sharing of campaign media in the selected interest category, then the recipient is added to the sending member client's GoldCloud. If the recipient denies the share request, then the sender is notified to send the share request to another connected member. In step 328, a minimum of 3 approved share requests are required to activate a GoldCloud. Participates of active GoldClouds are prompted to share when the owning member client 104 shares a GoldCloud campaign 120 listed in the same interest category 433 and 436 as active GoldCloud. Data from the established GoldClouds and participates therein are stored in the device's memory 122 and virtual data store 110.

### Sharing Goldcloud Campaign

FIG. 5 illustrates the process by which member client 104 complete the campaign share process, wherein points are awarded to member client 104 for the completion of each campaign segment of a GoldCloud campaign 120. This is a novel process of the invention as it describes the member client 104 action required in the digital media promotion method of claims. In step 504, member client 104 access campaign listings in user interface 106. In step 506, active campaign listings are update by server 112 and displayed as shown in FIG. 4.2, wherein listings are filtered by interest category 436 and by city via icon 435. In step 508, member client 104 chooses a campaign to share by tapping on campaign media 444 or a share icon 439 which initiates the display of selected campaign details 510 as shown in FIG. 4.3, wherein member client 104 may initiate share by tapping share icon 439 for selected network 514. In step 518, software verifies if a member is logged into a social profile on selected network, and if not, displays login/sign up portal 516.

In step 520, upon verification of login, the software begins the campaign segment by downloading sharable campaign media and caption from data stores 110, and publishing media and caption to the social profile on selected social network 108. In step 526, instructions for the campaign segment interaction is displayed as shown in FIG. 4.4, FIG. 4.5, FIG. 4.6, FIG. 4.7. Member client 104 may choose to initiate the campaign segment interaction or proceed to the next segment and skip interaction 528.

If the interaction of 528 is skipped, then the software verifies if additional campaign segments exist 534 in the initiated GoldCloud campaign 120. If additional segments do exist, then the software repeats step 520 wherein the next segment of media is used in step 520, and the next segment interaction is displayed in step 526. The “campaign segment loop” described in steps 520-534 is continued for each campaign segment in the defined campaign level as illustrated in FIG. 2.8.

### Initated Capture-Share

If the interaction of 528 is initiated, the software begins either capture-share (see FIG. 3.4) or campaign game interaction (see FIG. 3.5) after a 3-second countdown of 530. FIG. 3.4 describes the process of member client 104 completing the capture-share segment interaction. In step 346, member client 104 chooses to initiate capture-share segment interaction 528. In steps 348 and 349, the software connects to the device's GPS processor 128 to verify if the device is located inside of the defined GPS coordinates 448 set by admin client 100. If the device is not located inside of the defined radius 448, then dialogue moves to end share process 349. If the device is located inside of defined radius 448, then game timer 454 begins and the view controller displays the capture-share game screen (see FIG. 4.7) with camera view using image sensors 470 and a description of subject 472 to be captured 350, 352. Camera view 470 is disabled when device 102 is no longer located inside defined radius 448.

In step 354, member client 104 is awarded points for performing capture-share haptic contact engagement patterns previously described while device 102 is located inside of defined GPS radius 448 until game timer 454 expires. In steps 358, 360 and 361, software verifies if segment goal 452 was reached, and if not reached, (either) displays dialogue to repeat gameplay or forfeit share 362. If member client 104 chooses to repeat gameplay, the process returns to step 348. If goal 452 is reached, the software stores the score in the application during 3-hour validation period 366.

In step 368, post interactions values are calculated during the validation period for each media element captured and uploaded during gameplay. In steps 369 and 370, post interactions values are compared to the QA limit set be admin client 100, wherein published media with values that are lower than the QA limit are flagged for review 370 by admin client 100 and may be disqualified. Awarded game points are deducted from member client's 104 stored score for each disqualified post. Qualified published media postings have a post interaction value equal to or greater than the set QA limit. In step 372, member client's 104 final score after deduction is compared to game point table 264, and the GCP value is credited to the member's balance. In step 374, the software displays a campaign level completion dialogue (see FIG. 4.8) and updates the data on virtual server 112 and data stores 110.

### Initated Campaign Game

FIG. 3.5 describes the process of member client 104 completing a campaign game segment interaction during the sharing method of the invention. In step 376, member client 104 chooses to initiate campaign game segment interaction 528. In step 378, software displays the game view for an assigned campaign game as shown in FIG. 4.4, FIG. 4.5, and FIG. 4.6, wherein game timer 454 is initiated at the end of a 3-second countdown 530. In steps 380 and 532, member client 104 performs haptic contact engagement patterns previously described to earn points until game timer 454 expires. In steps 382 and 384, software verifies if goal limit 452 was reached during gameplay, and if not, displays dialogue to either replay the game segment or forfeit share 388. If member client 104 chooses to replay segment, the process returns to step 378. If the goal was reached, the score is compared to the game point table to determine awarded value 390. Award values are credited to the member's balance, and data is updated on virtual server 112 and data stores 110.

### Goldcloud Share

In step 534 (see FIG. 5), the software verifies the existence of additional campaign segments in initiated GoldCloud campaign 120 at the completion of gameplay and before final scores are assessed; and if exists, process returns to step 520 and initiates the next campaign segment. If no additional campaign segments exist, this signals the completion of the campaign level. In step 536, the software verifies if sharing member client 104 has an active GoldCloud within the same interest category 436 as initiated campaign 120, and if so, notifies participates of the active GoldCloud, prompting them to complete the same campaign share 538. The GoldCloud share flow is then initiated as described in FIG. 3.3, wherein each participant's post interactions are calculated 24-hours after publishing shared campaign media to determine power points earned 340. In step 342, power points generated by the participates of GoldCloud are combined and compared to the power point table for GoldCloud shares to assess GCP value awarded to each participator's balance. Only participates who complete prompted campaign share are awarded GCP value for GoldCloud shares.

If no active GoldCloud is found, the software proceeds to step 540, wherein the software calculates game points earned during gameplay and compares the total score to game point table 246 to determine the GCP value to be credited. In step 542, member client 140 is credited assessed values. In step 544, the campaign level completion dialogue is displayed (see FIG. 4.8), and all data is updated in virtual server 112 and data stores 110. This is the completion of the campaign share process.

### Post Interaction

Post interactions are calculated for each published media element shared by member client 104. Power points value is determined by formula: Power Points=(Likes+Shares)/3 wherein likes and shares for posts are combined and divide by 3, then rounded to the nearest whole number. Power points are accumulated for 7-days, then the software converts the balance into GCP value assessed by a power point table.

### Campaign Level Completion Dialogue

FIG. 4.8 illustrates the campaign level completion dialogue displayed to member client 104 in user interface 106 at the completion of a campaign level. Campaign title 477 and awarded values 478 including GCP, CRC, tokens, and badges are displayed to alert the member. If the campaign has awarded media, member client 104 may choose to download using button 480. Leaderboards may be viewed by using button 482, or member client 104 may continue to the campaign listings with button 483.

### Admin Dashboard

FIG. 2.3 illustrates the dashboard of the administrative control panel 114, wherein admin client 100 can monitor and manage network activity. The new user review section is the area where applicants for membership are reviewed, approved, or denied. The user-generated content module or UGCM is where media 117 submitted by member client 104 is reviewed, approved, or denied for inclusion in GoldCloud campaign 120. Approved media 117 is displayed in campaign creation module 264. The campaign activity module 238 displays impression and share activity of active GoldCloud campaigns 120, including, but not limited to the number of views of campaign details, number of shares of a campaign, and the number of shares to connect networks. The network data module 240 visually displays user data in graphs, charts, and diagrams including, but not limited to ranked GCP balances, share totals, CRC balances, and GoldCloud owners.

### Badges & User Roles

FIG. 2.10 illustrates the badge module in the administrative control panel 114, wherein the admin client manages badges activities within the virtual community. Badges are designed to award member clients 104 for completing community activities and achievements. The new badge module 297 allows admin client 100 to upload a badge image, set unlock activity from a list of community activities, and set value to unlock. Example: Title: New Badge, (Icon), unlocked by: 30 Completed campaign shares. Once created, the new badge is displayed in existing badge module 300. A new combination of badges are created in combination module 299, wherein two, three, or four existing badges may be selected along with an open community activity, award type/value, or user role to establish new badge combinations. Active combinations are displayed in active combination module 301. Badge combinations are design to be a path for member clients 104 to progress in the user role within the community. User roles are defined by limitations to simultaneously activate GoldClouds and the number of allowed participates therein, whereas each;
I. Role 1 user is not allowed to activate or participate in GoldClouds. Role is unlocked by submission of valid referral code and membership application approval by admin client 100,
II. Role 2 user is allowed 1 simultaneously active GoldCloud with a participate limit of 5 members. Participates may include only other Role 2 users. Role is unlocked by user purchase of or exchange of monetary value for access to campaign listings,
III. Role 3 user is allowed 3 simultaneously active GoldClouds with a participate limit of 8 members. Participates may include only Role 3 and Role 2 users. Role is unlocked by combination of badges earned by the activities of successfully inviting new users, completing assignments, and total game point acquired from gameplay,
IV. Role 4 user is allowed 5 simultaneously active GoldClouds with a participate limit of 10 members. Participates may include only Role 2, Role 3, and Role 4 users. Role is unlocked by combination of badges earned by the activities of completing GoldCloud share, inviting new users, total power points acquired, and total game point acquired from gameplay,
V. Role 5 user is not limited to a number of simultaneously active GoldClouds with participate limit of 10 members. Participates may include only Role 4, and other Role 5 users. Role is unlocked by combination of badges earned by the activities of completing GoldCloud share, completing user-generated media submission, total number of GoldClouds, total Power points acquired, total GCP or CRC acquired and total game point acquired from gameplay.
   Member client 104 redeem combinations of badges to unlock user roles and new Tokens, wherein upon redemption, badges are reset to be unlocked again. In another embodiment, the blockchain can be used to manage the delivery of digital rewards (e.i. badges, Power points, GCP and CRC). In this embodiment, when member client 104 completes activities designated by admin client 100 the completion is stored as a transaction. Once all activities have been completed and verified by the blockchain, then the assigned rewards are released to member client 104.

### Submitting GCP Conversion Request

FIG. 4 describes the process of member client 104 submitting a GCP conversion request to be reviewed by admin client 100 in conversion request module 252 shown in FIG. 2.5. This is a novel process of the invention, as it is the action required by member client 104 to accomplish monetary aspects of the claim. In step 402, member client 104 accesses user interface 106. In step 404, the software checks settings on virtual server 112 to verify if the conversion request is toggled to active in conversion & invitation request module 242, and if not, the conversion request is in-active 406 and the process ends. If active, member client 104 progresses to select “Convert GCP” option 408 from the menu in user interface 104. In steps 410 and 412, the conversion request module is displayed as shown in FIG. 4.9, wherein conversion amounts 484 set by admin client 100 in the conversion amounts module 247 are displayed in the dropdown menu to be selected by member client 104 and submitted 486 as a conversion request. In step 414, the software checks data stores 110 to verify if member client 100 has completed 3 successful referrals within the past 20 days, and if not, displays dialogue instructing the member to complete the remaining referrals. If the referrals have been completed, the process progresses to step 418, wherein the software verifies member client 104 has 3^{rd} party payment processor credentials stored in data stores 110. If credentials are not found, the software displays dialogue 420 prompting member client 104 to input valid credentials 422. Member client's 104 input is verified in step 426, and if not invalid, the dialogue is displayed 428 and the processes ends. Once credentials are verified, the software displays a conversion request confirmation dialogue 424. In step 430, member client 100 confirms the GCP conversion request and it is stored on server 112 for review 432 by admin client 100.

### Approving GCP Conversion Request

FIG. 6 describes the process of admin client 100 approving and denying a GCP conversion request submitted by member client 104. This is a novel process of the invention as it is the admin client 100 action required to accomplish monetary aspects of claims. In steps 602 and 604, admin client 100 access payouts section 252 from dashboard 232 of the administrative control panel and software displays view as shown in FIG. 2.5. In step 606, admin client 100 selects GCP conversion request module 253, which initiates calls to server 112 to display conversion request 608 submitted by member client 104. From conversion request module 253, admin client 100 may review the request details comprising of the sender's full name, GCP amount being converted, credit amount being issued, and the request timestamp. Admin client 100 may also search the conversion history by accessing GCP conversion database 254. In steps 610, 612, and 614, admin client 100 denies the conversion request, by initiating software to email requesting member client 104 and updating server 112 and data stores 110. Upon admin client 100 approval of the conversion request, the software deducts the converted GCP amount from requesting member 104 balance, sending monetary credit to requesting member 104 stored user ID via API 616, provided by 3^{rd} party payment processor 116. In step 618, the software deducts credited amounts of approved requests from the available bank balance displayed in user interface 106, then updates virtual server 112 and data stores 110.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

### Glossary/Terms

Members: Used to describe non-admin users who complete community activities while functioning in designated user roles.

Connect Members: Users connected to each other within virtual community by request or referral.

User Roles: Five access roles for member of virtual community with limitations on simultaneously active GoldCloud and the amount of participates therein.

Campaign Segment Interaction: Assigned code categorized as capture-share or campaign game segments that execute between campaign media segments during shares in which user is prompted by software to interact with device or current surroundings by performing haptic contact engagement patterns for a timed duration to accumulate points

Campaign Game: Assigned code that executes between sharable media segments during campaign shares in which user accumulates points in a timed session by interacting with pre-defined objects displayed for various time intervals. User must collect a minimum number of points (or goal limit) before the game timer expires to initiate the sharing of the next content segment. If goal is not met, user must repeat the game until the goal is reached or forfeit the share.

Game Difficulty Levels: Defined values programmed into campaign segment interactions that determine rate of movement, display time game icons, goal values for campaign game segments, and number of description set for capture-share interaction.

Capture-Share Action: Assigned code that executes between campaign media segments during shares in which member accumulates points in a timed session for using camera on device to capture defined content within a GPS radius, and sharing captured content with connected social network. Device must be located within defined GPS radius to trigger camera and on-screen description of nearby content to be captured as related to campaign. Descriptions are limited to 40 characters. Example: “Selfie-Vid with your favorite tea”

Badges: Tokens unlocked by achieving defined levels of activity within the virtual community centered around sharing campaigns, earning points and awards, inviting new user and unlocking content & achievements. Examples of badge achievements are as follows:

Share Badges—# of Competed Shares, Completed Assignments

Earn Badges—Accumulate set amounts of GCP, and set amounts of CRC

Invite Badges—# of Referrals

Grow Badges—Unlocked campaigns, create GoldClouds, add new participates to GoldClouds

Campaign Share: Publishing of content by user to a social network. User completes a share when all media segments in campaign level have been shared to the selected social network.

GoldCloud Share: When all members of an active GoldCloud complete the sharing of the campaign originally shared by the owner of the GoldCloud.

Awards and Award Types: Digital incentives provided to members for completing community activities. Award types include GCP, CRC, Tokens, Badge, and downloadable media.

Active GoldCloud: Groups of 3 or more members who are prompted to share a campaign once the owning member completes the share first. All members of an active GoldCloud are credited power points when the entire group completes the sharing of the same campaign. Member may send a request to other members they've previously referred or members whom follow them to join their GoldClouds. A minimum of three (3) request approvals from active members is required to activate a GoldCloud.

Game Points: Points earned during participation in campaign segment interactions. Game points are converted into GCP values assessed by game point table.

Game Point Tables: a table set by administrator client that assess value of GCP credited to member for earned game points.

Power Points: Points accumulated for post interactions on social platforms to which the user publishes content media segments. Each member's power points are converted into GCP based on power point table limits set my administrator.

Power Point Tables: data table for the 7-day conversion cycle of power points into GCP. Administrator sets all limits and credits for each user role before campaign creation. There are 2 power point tables to convert power points, one for individual shares and one for GoldCloud shares.

GCP (GoldCloud Points): Points collected by users for completing individual campaign shares, GoldCloud share, participation in campaign segment interactions, successful referrals, and the completion of assignments. Upon user request and administrative approval, GCP may be converted into monetary credits issued to a digital wallet by a 3^{rd} party payment processor.

CRC (Campaign Release Credits): Credits earned by member for completing each campaign segment. A set value of CRC determined by administrators is deducted from member's balance when they send invitations to new users.

Bonus GCP: GCP awarded for completing assignments and GoldCloud shares. Assignment bonus may be set by administrator during campaign level creation. Assignment bonus may also be set by contributing member on their UGGC for inaugural campaign release.

Tokens: Virtual items earned by member for completing activities assigned by administrator. A token can be redeemed multiple times within the virtual community and can be displayed as user-generated GoldCloud campaign (UGGC) activation credit.

Community Activities: Member participation in the following organic actions and achievements defined within the virtual community; including the gameplay, campaign shares, GoldCloud shares, the submission of UGGC, earning top placement on leaderboards, redemption of badge combination, GCP conversion value, invitations sent, unlocking additional content and completing purchase or currency exchange
Completing of individual and collective campaign share
Completing campaign assignments
Unlocking new campaigns
Creating and adding participates to GoldClouds
Completing of successful referral of new members with User Role 2 access or higher
Participating in campaign segment interactions
Contributing media approved for UGGC
Accumulating shares of contributed UGGC
Accumulating Power point values wherein values are displayed as Badges
Converting credit values wherein values are displayed as Badges

UGGC (User-generated GoldCloud Campaign): A GoldCloud campaign established with media segments submitted by the member. A minimum of 2 or more segments of photos, audio, and video are required to complete a submission. The media must be submitted in acceptable format and be no larger than 500 MB in size. A redeemed Token is attached to the submission to identify ownership and credit shares.

UGCM (User-generated Content Module): located on the dashboard of the admin control panel wherein the administrator reviews, approves and denies media submitted by members of virtual community.

Bank: Amount available for the conversion of GCP into monetary credits. The amount is set by administrator in the control panel. This balance is displayed to members in the user interface. As administrator approves the member's GCP conversion requests, monetary credits issued to the digital wallet are deducted from the bank balance.

Campaign Media: short sizzle trailers and slider images uploaded to establish a GoldCloud campaign.

Sharable campaign media: Multimedia content uploaded to the virtual server for users to share through the user interface. Content can be in the forms of audio, video, or images.

Campaign Segment Interaction: Activity initiated between campaign segments during a share that requires user interaction with a device or surroundings. Example: (1) Assigned campaign game or (2) Capture-upload actions between each campaign segment

Campaign Levels: Layer of campaign that contains the campaign media segments and segment interactions. Admin can set the number of segments (2-9), assignments, level timer, slider images and video, and the description for each campaign level.

Assignments: Timed incentives added to campaign levels that awards users GCP, CRC, Tokens, or Badges when they complete the sharing of that level. Assignments expire at the end time set by Admin.

1. A digital media promotion system to monetize the sharing of exclusive media content with social audiences on other user-generated content networks comprising of;
Software executing on an internet-connected computing device possessing an interactive display, integrated GPS chip, and digital image sensors to capture visual media; accessing exclusive media content and campaign parameters from an administrative control panel and data stores hosted on a virtual server;
wherein the administrative panel enables client to;
a) establish network parameters for the virtual community consisting of activation and de-activation of invitation requests and GCP conversion requests, setting conversion amounts allowed to be requested, and setting the available bank balance;
b) set award types and values credited to members of the virtual community for the completion of set community activities;
c) create GoldCloud campaign(s) by uploading and selecting campaign media and campaign parameters, to be shared, displayed, and executed during a user initiated campaign share;
d) manage and monitor GoldCloud campaigns created and campaign activity within the virtual community,
wherein software enables members to;
e) redeem combinations of badges to unlock user roles and new Tokens, wherein badges are unlocked by completing various community activities and upon redemption, badges are reset to be unlocked again
f) send time-sensitive personal invitation to join the virtual community containing a unique referral code inputted during the enrollment process, wherein the value of the CRC is deducted from the sender's balance for each invitation sent;
g) upload media and textual details to be reviewed, rejected, or approved by administrator, wherein upon approval, the media is used to establish user-generated GoldCloud campaign (UGGC) and the contributing member is credited GCP for the completed shares of UGGC,
h) accumulate points for completing campaign shares and other community activities within the virtual community, wherein earned points are converted by an exchange into GCP value and other award types as determined by parameters set in the administrative control panel,
and wherein administrative panel enables admin client to;
i) approve and deny conversion requests from members to convert set amounts of GCP into monetary credits issued to their digital wallet, wherein upon approval, monetary credits are issued by a 3^{rd} party payment processor via API.

2. The system of claim 1a wherein activation of an invitation and conversion request allows a member to access respective functionality or where de-activation denies access, and wherein the bank balance is displayed to a member in the user interface.

3. The system of claim 1b wherein:
a. Award values include amounts issued for completed UGGC shares,
b. Award types and values are required to be set before campaign creation,
c. Award types consist of GCP, CRC, Tokens, Badges, or downloadable media.
and wherein community activities consist of:
a. Completing of individual and collective campaign share
b. Completing campaign assignments
c. Unlocking new campaigns
d. Creating and adding participates to GoldClouds
e. Completing of successful referral of new members with User Role 2 access or higher
f. Participating in campaign segment interactions
g. Contributing media approved for UGGC
h. Accumulating shares of contributed UGGC
i. Accumulating Power point values wherein values are displayed as Badges
j. Converting credit values wherein values are displayed a Badges.

4. The system of claim 1c wherein:
a. campaign media is in the native format of the receiving social platform
b. selected campaign media consist of approved user-generated media
c. campaign parameter consists of media displayed to members, published media, campaign details, campaign levels, campaign assignments, value credited to contributing member (if UGGC), and campaign segment interactions,
and wherein campaign media and parameters are executed on user interface upon updating virtual server.

5. The system of claim 1d wherein campaign activity includes all data gathered from the user's haptic contact engagements with campaign listing, and wherein manage functionality consist of resetting, exporting, searching, filtering, and tracking said data.

6. The system of claim 1e wherein community activities to be completed are as described in 2a-I and wherein combinations are set by administrator in the badge module.

7. The system of claim 1e wherein user roles are defined by limitations to simultaneously active GoldClouds and the number of allowed participates therein.

8. The system of claim 1f wherein the enrollment process is comprised of:
a. Client inputting recipient's information and sends invitation containing referral code,
b. Software sending invitation to recipient and begins validation period,
c. Client submitting membership application, including provided referral code and the granting of social profile permissions,
d. Admin client reviewing, approving and or denying of new user applications wherein upon approval, member is considered a role 1 user.

9. The system of claim 1g wherein shares of UGGC are tracked as in the described in claim 4, and wherein credit value awarded to a contributing member per share of UGGC is set during campaign creation by administrator.

10. The system of claim 1g wherein the approval process for UGGC consist of:
a. Client uploading media sourced on device in user interface or to member-access website portal,
b. Software deducting one Token per user media submission and displays media in UGCM module for review
c. Admin client reviewing media and details and approves media in UGCM,
d. Media listed as approved media contributed by submitting member available for selection during campaign creation process.

11. The system of claim 1h wherein the sharing of a campaign media segment is conducted using the API provided, by receiving a user-generated content platform, wherein campaign community activities are as described in claim 2, and wherein award types can be GCP, CRC, Tokens, Badges, or downloadable media.

12. The system of claim 1h wherein point values are compared to Power point tables and game point tables to determine GCP value issued to a member as set by administrator.

13. The system of claim 1i wherein approved conversion request amounts are deducted from the available Bank balance and updated in the user interface, and wherein all conversions requested as stored in data store.

14. A digital media promotion method to monetize the sharing of exclusive media with social audiences on other user-generated content networks wherein members of the virtual community earn points for completing campaign shares and participating in campaign segment interactions presented between the sharing of campaign media segments, executed in the following process:
a) Admin client establishes network parameters, award values and credits to be issued from administrative control panel,
b) Admin client creates GoldCloud campaign in administrative control panel,
c) Member client selects GoldCloud campaign and initiates share to social network from user interface,
d) Software shares campaign media segment to selected social network using API,
e) Member client initiates or disregards campaign segment interaction,
f) Software calculates awarded point totals and compares to game point table,
g) Software calculates post interactions and compare to power point tables,
h) Software displays campaign level completion dialogue,
i) Software issues GCP values determined by comparisons to member's balance,
j) Member client completes GCP conversion request for set amount as determined by network parameters,
k) Admin client denies or approves GCP conversion request,
l) Software issues monetary credits to member and or downloadable media.

15. The method of claim 14b wherein a GoldCloud campaign creation is comprised of the admin client completing the following steps in the campaign creation module:
a. Inputs campaign title, description, shared caption, listing cities, interest category, latitude and longitude coordinates, URL link, start date, start time, end date, end time,
b. Selects social platform(s) to which campaign segment media is shared
c. Selects number of campaign levels and segments for each, and if more than one level, then set reduced timer for each levels proceeding the first,
d. Sets assignment values for selected levels comprising of max participant limit, start time, end time, start date, end date, and bonus points awarded,
e. Selects campaign segment interaction and set difficultly levels or description for each segment
f. Uploads campaign media to data stores consisting of slider content for each level and segment media for each segment
g. Submit all campaign content and parameters to virtual server to schedule the release of campaign within the virtual community.

16. The method of claim 14c wherein active GoldCloud campaigns are filtered by interest and location.

17. The method of claim 14e wherein campaign segment interactions can be either capture-share or campaign game in which points are earned for haptic contact patterns registered during a brief expiry time period, and wherein set point value is assessed for disregarded segments.

18. The method of claim 14d and 14e wherein the number of campaign segment media shares and campaign segment interactions displayed during campaign share, is during the campaign creation process, and steps can be repeated as assigned.

19. The method of claim 14f and 14g wherein values and levels for the power point table, GoldCloud power point table, and game point table are set by the admin client in administrative control panel before campaign creation.

20. The method of claim 14l wherein monetary credits are issued to digital wallet by 3^{rd} party payment processor via API.

21. A digital media promotion method to establish and monetize a GoldCloud within a virtual community comprised of:
a) Client redemption of a token to establish a GoldCloud within an interest category,
a) Client inviting at least 3 connected members with same interests to join and activate established GoldCloud,
b) Client initiating GoldCloud share by sharing an active campaign within the same interest category as active GoldCloud,
c) Software notifying participants of active GoldCloud prompting to share the same campaign before expiration,
d) Software calculating post interactions from published media for each participant,
e) Software combining power points generated by all participates in GoldCloud and compare to power point table for GoldCloud shares to determine GCP value to be credited,
f) Software crediting assessed GCP value to owner and participants of active GoldCloud,
g) Client submission of GCP conversion request for review by administrator,
h) Admin client approval of GCP conversion request and issuance of monetary credits to requesting member's digital wallet.

22. The method of claims 14 and 20 is executed using the system and processes described in claim 1.

23. The method of claim 20b wherein connected members are those previously referred to the virtual community and those approved to follow establishing member's updates, and wherein a minimal of 3 approved share requests are required to activate GoldCloud.

24. The method of claim 20f wherein values and levels for the power point table for GoldCloud share set by the admin client in administrative control panel before the creation of a campaign.

25. The method of claim 20g wherein only participants who completed an owner initiated campaign share are credited GCP value.

26. The method of claim 20i wherein monetary credits are issued to a digital wallet by 3^{rd} party payment processor via API.
